(19) United States
(12) Patent Application Publication
(10) Pub. No.: US 2024/0263804 A1
(43) Pub. Date: Aug. 8, 2024

(54) DEVICE AND METHOD FOR INTERIOR RADIATIVE HEATING/COOLING

(71) Applicant: THERMA-HEXX CORPORATION, Portsmouth, NH (US)

(72) Inventor: Robert P. Barmore, Portsmouth, NH (US)

(21) Appl. No.: 18/568,754

(22) PCT Filed: May 2, 2023
(86) PCT No.: PCT/US2023/020751

§ 371 Date: Dec. 8, 2023

Related U.S. Application Data
(60) Provisional application No. 63/337,463, filed on May 2, 2022.

(51) Int. Cl. F24D 3/14; E04C 2/52; F24F 3/14; F24F 5/00; F24F 110/20; F28F 13/12

(52) U.S. Cl. CPC F24D 3/14; E04C 2/525; F24F 5/0092; F24F 3/14; F24F 2110/20; F28F 13/12

(57) ABSTRACT

A modular thermal transfer emitter configured to be compatible with installation for indoor radiative heating and cooling. For example, modular emitters radiatively and conductively heat and/or cool an interior space in a building using a heat exchanger and tubing through which thermal fluid flows. These modular emitters can be arranged within a suspended ceiling, walls, flooring of a residential and commercial building. A system for exchanging heat from components can include multiple heat exchangers adjacent to the components and one or more pumps connected to the heat exchangers. The pumps can generate water flow that brings the heat to a secondary heat exchanger. Because the modular emitters can have a large area (e.g., spanning a significant percentage of the ceiling or wall) a desired amount of heat transfer can be achieved without requiring a large temperature difference between the thermal fluid and the ambient surroundings.

### TECHNICAL FIELD

The present disclosure relates generally to systems, methods, and apparatus for heating/cooling inside a building using modular hydronic thermal emitters for radiative and conductive heat transfer.

### BACKGROUND AND RELEVANT ART

Heating and cooling systems for enclosed spaces, such as in an office building, a residence, or and industrial building, often use forced air HVAC (heating ventilation, and air conditioning) systems. Forced-air heating/cooling systems use air as the heat transfer medium, which rely on ductwork, vents, and plenums as means of air distribution. Consequently, the ductwork in forced-air systems occupies a significant amount of space in the ceilings and walls of buildings, and if this space were freed up, it might be put to other productive uses. For example, by reducing the space devoted to the ductwork and to the blowers, heaters, and air conditioning units, additional stories might be added to high-rise buildings. Compared to air, water has 3,500 times the capacity to transport energy.

In contrast to forced air systems, hydronic heating in the form of hot-water radiators may be used for heating. However, hot-water radiators typically must have a very high temperature (e.g., 180 to 200 degrees F.), and they rely on convection to distribute the heat throughout the room.

Both forced air systems and hot-water radiator systems are typically centralized and controlled via a central thermostat. Accordingly, these systems can be ill suited for zoning in which different temperatures are set and modified for respective zones to be heated. These systems can also suffer from being inefficient and from not being very responsive. For example, to heat a house, a forced air systems first blows the cold air currently in the ductwork into the living space before the newly heated air has fully displaced the cold air previously in the ductwork and the heated air begins to heat the living space. Further, before the heated air enters the living space it is cooled in transit due to heat transfer from the heated air to the ductwork between the heater to the living space.

Hot-water radiators can be unresponsive because of the time it takes to heat the water, then transfer the heated water to the radiator, and then the time it takes for heat transfer from the heated water to raise the temperature of the large thermal mass hot-water radiator, and subsequently convect heat throughout the space unevenly.

Accordingly, improved heating and cooling systems are desired.

### BRIEF SUMMARY OF THE INVENTION

One embodiment illustrated herein includes a radiative heating and/or cooling system. The heating and/or cooling system includes modular hydronic thermal emitters fixed within a building and being arranged to span a substantial part of an interior surface of the building. Each of the modular thermal emitters comprising a planar member having channels disposed therein conveying a thermal fluid from an inlet of one of the modular thermal emitters to an outlet of the one of the modular thermal emitters. The plurality of modular thermal emitters comprises a fluid conduit configured to convey the thermal fluid from the outlet of the one of the modular thermal emitters to an inlet of another of the modular thermal emitters. The heating and/or cooling system further includes a controller configured to control a flow of the thermal fluid through the modular thermal emitters.

In another embodiment illustrated herein, the heating and/or cooling system includes a humidity regulator that measures a humidity of the building and modifies the humidity to maintain a dew point temperature below a temperature of the plurality of modular thermal emitters.

In another embodiment illustrated herein, the interior surface is a wall and/or a ceiling of an enclosed space of the building, and the building is a residential building, a commercial building, or an industrial building.

In another embodiment illustrated herein, one of the modular thermal emitters in fluid communication with another of the modular thermal emitters via the fluid conduit without any mechanical connectors along a pathway of the thermal fluid from the one of the modular thermal emitters to the another of the modular thermal emitters.

In another embodiment illustrated herein, the modular thermal emitters are reconfigurable by utilizing removable ceiling panels or tiles to access the emitters.

In another embodiment illustrated herein, the modular thermal emitters are fixed to the interior surface of the building using a channel support structure that is fixed to the interior surface, and channels in the channel support structure hold the modular thermal emitters along a periphery of the modular thermal emitters.

In another embodiment illustrated herein, the channel support structure comprises anti-uplift structures that prevent movement of the modular thermal emitters in response to a change in room pressure.

In another embodiment illustrated herein, the modular thermal emitters are fixed to the interior surface of the building using one of: (1) one or more fasteners secured to the interior surface of the building through one or more preformed attachment points within the respective modular thermal emitters; (2) attachments to a support lattice for a suspended ceiling; (3) one or more fasteners securing the modular thermal emitters to framing members, rafters, ceiling beams, or ceiling trusses; (4) a channel supporting a perimeter of the modular thermal emitters, fasteners fixing the channel either to one or more sheets of dry wall, one or more concrete masonry units (CMUs), or structural wall or ceiling; or (5) suspending the modular thermal emitters from a structural ceiling using suspension wire or using a suspension fastener.

In another embodiment illustrated herein, when the thermal fluid fills the channels or a respective modular thermal panel of the modular thermal emitters, a ratio of a thermal mass of the thermal fluid to a thermal mass of the respective modular thermal emitter is greater than 0.5.

In another embodiment illustrated herein, the modular thermal emitters are fixed to the interior surface in a manner that reduces or eliminates a plenum space relative to a forced air heating and/or cooling system.

In another embodiment illustrated herein, a temperature of the thermal fluid changes in a direction towards a room temperature as the thermal fluid flows through the respective modular thermal emitters, and an order of the thermal fluid flow through the respective modular thermal emitters is set to more uniformly heat and/or cool the building relative to an order of the thermal fluid flow in which the thermal fluid flow is conveyed from a current modular thermal emitter to a next closest modular thermal emitter.

In another embodiment illustrated herein, the modular thermal emitters are preassembled into groups of two or more modular thermal emitters thereby improving case of installation.

In another embodiment illustrated herein, the groups of two or more modular thermal emitters are configured to be installed by sliding the groups of two or more modular thermal emitters into respective channels attached to the interior surface of the building.

In another embodiment illustrated herein, the heating and/or cooling system includes a thermal insulator in thermal communication with a first face of the planar member, the first face facing towards a plenum space.

In another embodiment illustrated herein, the heating and/or cooling system includes a thermal conductor in thermal communication with a second face of the planar member, the second face facing away from the plenum space and towards the interior of the building, the thermal conductor being one of a ceiling tile, an acoustic tile, a decorative tile, a wall panel, a plaster, or one or more sheets of drywall.

In another embodiment illustrated herein, the channels are non-circular and are molded between two sheets that form the planar member.

In another embodiment illustrated herein, an input channel conveys the thermal fluid from an inlet, the input channel fans out and bifurcates into branches spanning a substantial part of the planar member, and the branches combine to form an output channel conveying the fluid to an outlet.

In another embodiment illustrated herein, the channels are shaped to make turbulent a flow of the thermal fluid to increase the transfer of heat through the channel walls.

In another embodiment illustrated herein, the outer contour of the modular thermal emitters results in a surface area that is greater than a footprint of the modular thermal emitters, and a ratio of the surface area of the modular thermal panel to the footprint of the modular thermal panel is 115%, 130%, 145%, or greater.

In another embodiment illustrated herein, the outer contour of the modular thermal emitters results in a surface area that is greater than a footprint of the modular thermal emitters, and a ratio of the surface area of the modular thermal panel to the footprint of the modular thermal panel is 145%.

In another embodiment illustrated herein, the building is zoned to have a greater density of the modular thermal emitters in zones requiring more heat transfer.

In another embodiment illustrated herein, the modular thermal emitters are attached to a suspended ceiling using an attachment structure configured to attach to a horizontal portion of the support lattice of the suspended ceiling. A lower portion of the support lattice has a cross-section shaped as an inverted T-shape and the horizontal portion of the support lattice corresponds to a bottom of the inverted T-shape. And the attachment structure includes a hook that extends around one end of the horizontal portion of the support lattice and includes a foldable tab that folds over another end of the horizontal portion of the support lattice.

One embodiment illustrated herein includes a method of heat transfer using modular thermal emitters. The method includes arranging modular thermal emitters fixed within a building to span a substantial part of an interior surface of the building. Additionally, the method includes circulating a thermal fluid through channels in respective planar members of the modular thermal emitters, wherein each of the modular thermal emitters includes a planar member having channels disposed therein conveying a thermal fluid from an inlet of one of the modular thermal emitters to an outlet of the one of the modular thermal emitters; and the plurality of modular thermal emitters comprises a fluid conduit configured to convey the thermal fluid from the outlet of the one of the modular thermal emitters to an inlet of another of the modular thermal emitters. Further, the method includes controlling, using a controller, a flow of the thermal fluid through the modular thermal emitters.

In another embodiment illustrated herein, the above method further includes regulating a humidity using a humidity regulator that measures a humidity of the building and modifies the humidity to maintain a dew point temperature below a temperature of the plurality of modular thermal emitters.

In another embodiment illustrated herein, the step of arranging the modular thermal emitters further includes arranging the modular thermal emitters to span a substantial part of the interior surface of the building, wherein the interior surface is a wall and/or a ceiling of an enclosed space of the building, and the building is a residential building, a commercial building, or an industrial building.

In another embodiment illustrated herein, the above method further includes connecting the modular thermal emitters together via the fluid conduit such that the one of the modular thermal emitters in fluid communication with the another of the modular thermal emitters via the fluid conduit without any mechanical connectors along a pathway of the thermal fluid from the one of the modular thermal emitters to the another of the modular thermal emitters.

In another embodiment illustrated herein, the above method further includes reconfiguring the fluid conduit to change an order in which the thermal fluid flows through the modular thermal emitters, wherein the reconfiguring the fluid conduit is performed without disassembling the interior surface of the building.

In another embodiment illustrated herein, the step of arranging the modular thermal emitters further includes that the modular thermal emitters are fixed to the interior surface of the building using a channel support structure that is fixed to the interior surface, and channels in the channel support structure hold the modular thermal emitters along a periphery of the modular thermal emitters.

In another embodiment illustrated herein, the above method further includes that the channel support structure comprises anti-uplift structures that prevent movement of the modular thermal emitters in response to a change in room pressure.

In another embodiment illustrated herein, the step of arranging the modular thermal emitters further includes that the modular thermal emitters are fixed to the interior surface of the building using one of: (1) one or more fasteners secured to the interior surface of the building through one or more preformed attachment points within the respective modular thermal emitters; (2) attachments to a support lattice for a suspended ceiling; (3) one or more fasteners securing the modular thermal emitters to framing members, rafters, ceiling beams, or ceiling trusses; (4) a channel supporting a perimeter of the modular thermal emitters, fasteners fixing the channel either to one or more sheets of dry wall, one or more CMU's (concrete masonry units), or structural wall or ceiling, or (5) suspending the modular thermal emitters from a structural ceiling using suspension wire or using a suspension fastener.

In another embodiment illustrated herein, the step of circulating the thermal fluid through channels further includes that a thermal mass of the thermal fluid filling the channels of a respective modular thermal panel of the of modular thermal emitters is greater than 0.5 times a thermal mass of the respective modular thermal panel.

In another embodiment illustrated herein, the step of arranging the modular thermal emitters within the building further includes that the modular thermal emitters are fixed to the interior surface in a manner that reduces a plenum space relative to a method that uses forced air heating and/or cooling through ductwork.

In another embodiment illustrated herein, the step of circulating the thermal fluid further includes that a temperature of the thermal fluid changes in a direction towards a room temperature as the thermal fluid flows through the respective modular thermal emitters, and an order in which the thermal fluid flows through the respective modular thermal emitters is set to more uniformly heat and/or cool the building relative to an order of the thermal fluid flow in which the thermal fluid flow is conveyed from a current modular thermal pane to a next closest modular thermal panel.

In another embodiment illustrated herein, the above method further includes preassembling the modular thermal emitters into groups of two or more modular thermal emitters and installing the groups of two or more modular thermal emitters as a single unit to improve case of installation.

In another embodiment illustrated herein, the above method further includes installing the groups of two or more modular thermal emitters by sliding the groups of two or more modular thermal emitters into respective channels attached to the interior surface of the building.

In another embodiment illustrated herein, the above method further includes that each of the modular thermal emitters comprises a thermal insulator in thermal communication with a first face of the planar member, the first face facing towards a plenum space.

In another embodiment illustrated herein, the above method further includes that each of the modular thermal emitters comprises a thermal conductor in thermal communication with a second face of the planar member, and the second face facing away from the plenum space and towards an interior of the building, the thermal conductor being one of a ceiling tile, an acoustic tile, a decorative tile, a wall panel, a plaster, and one or more sheets of drywall.

In another embodiment illustrated herein, the above method further includes that the channels are non-circular and are molded between two sheets that form the planar member.

In another embodiment illustrated herein, the above method further includes conveying the thermal fluid through an inlet to an input channel, which fans out and bifurcates into branches spanning a substantial part of the planar member and the branches then recombine to form an output channel, wherein the thermal fluid is conveyed through the branches and into the output channel where the thermal fluid exits through an outlet of the planar member.

In another embodiment illustrated herein, the above method further includes turbulating the thermal fluid by the channels being shaped to turbulate a flow of the thermal fluid and to provide a a higher rate of heat transfer through the walls of the channels.

In another embodiment illustrated herein, the above method further includes turbulating the thermal fluid further includes that the channels are shaped to include off-center obstructions that turbulate the flow of the thermal fluid.

In another embodiment illustrated herein, the above method further includes zoning the building by arranging the modular thermal emitters to have a greater density of the modular thermal emitters in zones requiring more heat transfer.

In another embodiment illustrated herein, the above method further includes attaching the modular thermal emitters to a suspended ceiling using an attachment structure that attaches to a horizontal portion of a support lattice of the suspended ceiling, wherein a lower portion of the support lattice has a cross-section shaped as an inverted T-shape and the horizontal portion of the support lattice corresponds to a bottom of the inverted T-shape, and the attachment structure includes a hook that extends around one end of the horizontal portion of the support lattice and includes a foldable tab that folds over another end of the horizontal portion of the support lattice.

The present invention extends to methods, systems, and apparatus of modular, fluid thermal transfer device. A modular thermal transfer panel includes a heat exchanger, an inlet tube, and an outlet tube. The heat exchanger is formed with two emitters made of thermal conductive material. Multiple channels are formed between the two emitters allowing a heat exchange fluid to pass through. The inlet tube and outlet tube are respectively coupled to the heat exchanger for feeding and taking the heat exchange fluid. To provide more flexibility for installation, the inlet tube and outlet tube can be shaped at an angle to the channels.

One implementation of a method of manufacturing a heat exchange system using multiple modular thermal transfer emitters can involve identifying a layout pattern for multiple emitters. The method can then involve assembling multiple support members for supporting the emitters. The support members form assembly regions for receiving heat exchange components. After assembling the support members, the method can further involve positioning heat exchange components together with the multiple thermal transfer emitters in the assembly region. In addition, the method can involve connecting each thermal transfer panel to the adjacent one to create heat exchangers. Accordingly, the identified layout pattern, multiple fractal channels are formed between the thermal transfer emitters and the heat exchange components.

One implementation of a system for exchanging heat from components can include multiple heat exchangers adjacent to the components and one or more pumps connected to the heat exchangers. The pumps can generate water flow inside the heat exchangers and bring the heat to a secondary heat exchanger, thereby transferring heat from a room to an environment.

The modular thermal panel according to claim 1, wherein a ratio of a surface area of the modular thermal panel to a footprint of the modular thermal panel is 145%.

Additional features and advantages of exemplary implementations will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a bottom, perspective view of a suspended ceiling tiled using modular thermal emitters, according to an implementation of the present invention;

FIG. 2 illustrates a bottom, perspective view of a suspended ceiling tiled using modular thermal emitters and other ceiling tiles arranged every other tile, according to an implementation of the present invention;

FIG. 3 illustrates a top, perspective view of an example modular thermal panel having an insulator layer, according to an implementation of the present invention;

FIG. 4 illustrates a top view of an example heat transfer member of a modular thermal panel, according to an implementation of the present invention;

FIG. 5A illustrates a top view of an example heat transfer member without channels in the corner regions, according to an implementation of the present invention;

FIG. 5B illustrates a top view of an example heat transfer member with channels in the corner regions, according to an implementation of the present invention;

FIG. 5C illustrates a top view of an example heat transfer member with reinforced attachment regions, according to an implementation of the present invention;

FIG. 6A illustrates an example of an assembly of modular thermal emitters, according to an implementation of the present invention;

FIG. 6B illustrates another example of an assembly of modular thermal emitters arranged to connect next nearest neighbors, according to an implementation of the present invention;

FIG. 6C illustrates a third example of an assembly of modular thermal emitters arranged to provide more uniform heat transfer, according to an implementation of the present invention;

FIG. 7 illustrates a bottom perspective view of an example of a modular thermal panel having a decorative face/panel and conductive intermediary layer, according to an implementation of the present invention;

FIG. 8A illustrates a cross section an example of a suspended-ceiling connector that suspends the modular thermal emitters from a ceiling, according to an implementation of the present invention;

FIG. 8B illustrates a perspective view of another example of an assembly of the suspended-ceiling connector, according to an implementation of the present invention;

FIG. 9A illustrates a cross section of an example of a support lattice for a suspended ceiling, according to an implementation of the present invention;

FIG. 9B illustrates a cross section an example of a suspended-ceiling connector that suspends the modular thermal emitters from a ceiling, according to an implementation of the present invention;

FIG. 9C illustrates the suspended-ceiling connector being connected to the support lattice for the suspended ceiling, according to an implementation of the present invention;

FIG. 10A illustrates an example in which ceiling tiles and modular thermal emitters are supported by the support lattice and the connector, respectively, according to an implementation of the present invention;

FIG. 10B illustrates a second example in which modular thermal emitters are supported by the connector, according to an implementation of the present invention;

FIG. 10C illustrates a third example in which modular thermal emitters are supported by the connector, according to an implementation of the present invention;

FIG. 10D illustrates a fourth example in which modular thermal emitters are supported by the connector, according to an implementation of the present invention;

FIG. 11A illustrates an example of an H-shaped support structure for modular thermal emitters, according to an implementation of the present invention;

FIG. 11B illustrates an example of the H-shaped support structure attaching modular thermal emitters to a wall or ceiling, according to an implementation of the present invention;

FIG. 12A illustrates an example of attaching modular thermal emitters to a wall or ceiling, according to an implementation of the present invention;

FIG. 12B illustrates a second example of attaching modular thermal emitters to a wall or ceiling, according to an implementation of the present invention;

FIG. 12C illustrates a third example of attaching modular thermal emitters to a wall or ceiling, according to an implementation of the present invention;

FIG. 13A illustrates a perspective view of an example of connected modular thermal emitters for installation, according to an implementation of the present invention;

FIG. 13B illustrates a perspective view of a second example of connected modular thermal emitters for installation, according to an implementation of the present invention;

FIG. 13C illustrates a schematic of perspective view of a third example of connected modular thermal emitters for installation, according to an implementation of the present invention;

FIG. 13D illustrates another perspective view of a third example of connected modular thermal emitters for installation, according to an implementation of the present invention;

FIG. 13E illustrates a perspective view of an assembly of modular thermal emitters installed in a ceiling, according to an implementation of the present invention;

FIG. 14A illustrates a perspective view of an example of an assembly of a ceiling rail with a modular thermal emitter, according to an implementation of the present invention;

FIG. 14B illustrates a side view of an assembly of a ceiling rail with a modular thermal emitter, according to an implementation of the present invention;

FIG. 14C illustrates a zoomed-in, side view of an assembly of a ceiling rail with a modular thermal emitter, according to an implementation of the present invention;

FIG. 14D illustrates a cross-section example of a support rail, according to an implementation of the present invention;

FIG. 14E illustrates a perspective view of an example of a support rail, according to an implementation of the present invention;

FIG. 14F illustrates another side view of an assembly of a ceiling rail with a modular thermal emitter, according to an implementation of the present invention;

FIG. 15A illustrates a side view of hanging a modular thermal emitter from a ceiling rail, according to an implementation of the present invention;

FIG. 15B illustrates a side view of using a Therma-Hexx strut to hang a modular thermal emitter from a ceiling rail, according to an implementation of the present invention;

FIG. 15C illustrates another side view of hanging a modular thermal emitter from a ceiling rail, according to an implementation of the present invention;

FIG. 15D illustrates another side view of using a Therma-Hexx strut to hang a modular thermal emitter from a ceiling rail, according to an implementation of the present invention;

FIG. 16A illustrates a side view of bolting a modular thermal emitter from a ceiling rail, according to an implementation of the present invention; and

FIG. 16B illustrates another side view of suspending the modular thermal emitter using a bolted Therma-Hexx strut, according to an implementation of the present invention.

FIG. 17 illustrates an embodiment in which a strut functions as the rail 120;

FIG. 18A illustrates a first example of a modular thermal emitter having a non-rectangular shape, according to an implementation of the present invention;

FIG. 18B illustrates a second example of a modular thermal emitter having a non-rectangular shape, according to an implementation of the present invention;

FIG. 18C illustrates an example of a reverse return piping configuration, according to an implementation of the present invention;

FIG. 19 illustrates a schematic of a heating/cooling system, according to an implementation of the present invention;

FIG. 20 illustrates a flow diagram of a heating/cooling method, according to an implementation of the present invention;

FIG. 21 is a perspective view of a thermal paver system that includes modular thermal emitters similar to those described herein for use in ceilings and walls;

FIG. 22 is a side, cross-sectional view of the thermal paver system;

FIG. 23 is a Paver Trak™ for use with a thermal paver system;

FIG. 24 is an end view of the Paver Trak 1216;

FIG. 25 is a perspective view of a corner spacer for use with the Paver Trak in the thermal paver system of the present disclosure;

FIG. 26 is a top view of the corner spacer according to embodiments of the present disclosure;

FIG. 27 is a perspective view of a disk according to embodiments of the present disclosure;

FIG. 28 shows an edge restraint for use with the thermal paver system of the present disclosure;

FIG. 29 is a partial view of an end of an edge restraint for use with the thermal paver system;

FIG. 30 is a perspective view of a lift restraint assembly as part of the thermal paver system;

FIG. 31 is a perspective view of a corner assembly for a modular thermal unit, a foot, and a lift resistant assembly;

FIG. 32 is a perspective view of a lift restraint assembly according to embodiments of the present disclosure; and

FIG. 33 illustrates a schematic of controller for a heating/cooling system, according to an implementation of the present invention.

### DETAILED DESCRIPTION OF THE PREFERRED EMBODIMENTS

Implementations of the present invention solve one or more of the foregoing problems in the art with previous heating/cooling systems, methods, and apparatus. For example, embodiments disclosed herein enable modular emitters that perform radiative and conductive heating and/or cooling, Generally, the modular emitters are configured as panels (e.g., substantially planar structures), and the modular emitters could instead be referred to as modular panels. Further, the modular emitters can also function as absorbers, and the modular emitters could instead be referred to as modular panels. That is the term “emitter”, as used herein is non-limiting, and is used as shorthand for the more cumbersome term “modular thermal panel/absorber/emitter.”

According to certain embodiments disclosed herein, the modular emitters perform radiative and conductive heating and/or cooling to be installed in suspended ceilings. A suspended or dropped ceiling is a secondary ceiling, hung below the main (structural) ceiling. Suspended ceilings can be used in both residential and commercial applications. Suspended ceilings can beneficial be used to hide the building infrastructure, including piping and wiring by creating a plenum space above the dropped ceiling and allowing access for repairs. Further, the tiles used in the suspended ceiling can be made acoustically absorbing to avoid echoing and provide sound isolation between rooms.

Certain embodiments disclosed herein enable modular radiative heating/cooling emitters (or simply modular emitters) to the suspended in a suspended ceiling. For example, the suspended ceiling can include a support lattice for acoustic tiles from which a second support lattice is suspended that supports the modular emitters. Alternatively, the modular emitters may be integrated with the acoustic tiles to provide an integrated tile that both provides radiative heat transfer and provides acoustic dampening/absorption. In certain embodiments, a single support lattice can include respective support members for both modular emitters and the acoustic tiles. The support lattice can include through-holes through which suspension wires are fed, and the suspension wires connect the support lattice to a structural ceiling.

In certain embodiments, the density of modular emitters can be different in different rooms or in different parts of a room. For example, a first room might have more heat sources or have heat sources the generate more heat than a second room. Accordingly, the first room might have every other square of the suspended ceiling be a modular panel with the remaining squares occupied by acoustic tiles only. The second room might have every third square of the suspended ceiling be a modular panel with the remaining squares occupied by acoustic tiles only. Thus, the first room will be equipped with a greater heat transfer capacity than the second room, commensurate with the thermal loads of the respective rooms.

In certain embodiments, controllers and valves controlling the thermal fluid flow through the modular emitters can be used to regulate the amount of heat transfer in respective zones to provide zoning control of temperatures and heat transfer that is improved relative to centralized heating/cooling systems.

In certain embodiments, the heat transfer system can include a device that controls the humidity of the air. For radiative cooling to be most effective, the dew point temperature should be below the temperature of the modular emitters being used for radiation. Generally, the amount of radiative heat transfer is directly proportional to the area of the radiating device and is directly proportional to the temperature difference between the radiating device and the room/object being cooled. Thus, to achieve the same amount of heat transfer, there is a trade-off between increasing the area and increasing the temperature difference. Typically, for conventional radiating devices like hot-water radiators, practical considerations constrain the area of the conventional radiating devices to be rather small. To compensate for this small area, the temperature difference must be large, which might not present a significant problem for heating. But for cooling, a large temperature difference would require a prohibitive degree of dehumidification to push the dew point sufficiently low. For example, hot-water radiators must have a very high temperature (e.g., 180 to 200 degrees F.), and they rely on convection to distribute the heat throughout the room, resulting in significantly higher energy use compared to low temperature radiant emitters that cover a significant part of (or even a majority of) the ceiling, walls, or floor as needed. When heating water from 94 degrees f to 180 degrees significantly more energy is consumed in order to heat the same space.

In contrast, to conventional radiating devices, the heating/cooling area of modular thermal emitters can be quite large. Thus, obtaining the requisite humidity for effective cooling is not a problem when using the modular emitters for radiative cooling because the combined area of the modular emitters can be large, and therefore the temperature difference can be comparatively small (relative to conventional radiating devices) while still providing sufficient cooling. That is, because radiative thermal transfer is proportional to the total surface area of the modular emitters being deployed, which can be quite large when using the modular emitters compared to other radiative transfer devices (e.g., hot-water radiators), the temperature difference can be relatively small, and therefore a dehumidifier can easily achieve a dew point temperature below the temperature of the modular emitters.

In the above, non-limiting examples, the modular emitters are arranged within a building to provide radiative heating/cooling by fixing the modular emitters within a suspended ceiling. In addition to or in alternative to fixing the modular emitters within a suspended ceiling, the modular emitters may be arranged to provide radiative heating/cooling by fixing the modular emitters to a wall or within a wall. Additionally, or alternatively, the modular emitters may be arranged to provide radiative heating/cooling by fixing the modular emitters to a ceiling or within a ceiling. For example, the modular emitters may be fixed to or integrated within any interior surface within a building, whether the building is residential, commercial, or industrial. Thus, it will be recognized that any disclosure herein related to an embodiment of the modular emitters being attached to a wall may be extended to other embodiments in which the modular emitters are attached to a ceiling, and vice versa. Additionally, these disclosures also extend to embodiments in which the modular emitters may be attached to other structures within a building, including, e.g., support columns, roof beams, framing members, furniture, and appliances.

Further, the modular nature of the modular emitters provides several advantages. In particular, the modular design of the implementations of the present invention allows replacing only part of the whole system, if a leak occurs in one of the modular emitters. Further the use of modular emitters avoids forming channels inside ceilings or walls (e.g., pex tubing or aluminum tubing within sheetrock).

Implementations of the present invention can include multiple modular thermal emitters made of thermal conductive material (e.g., aluminum) with channels formed inside. The modular thermal emitters can be connected together and configured in a suspended ceiling such as being adjacent with or integrated with acoustic tiles. When thermal fluid (e.g., water) runs through the channels, it takes away the heat from the thermal conductive material. By keeping the thermal mass of the thermal conductive material relatively small, the temperature of the thermal conductive material can be changed quickly to correspond with the temperature of the thermal fluid, which is assumed to be water but is not limited thereto. The thermal mass of a given material may be calculated by multiplying its mass and the specific heat of the given material. Additionally, the small thermal mass of the thermal conductive material promotes efficiency by reducing the amount of thermal energy needed to change the temperature of the thermal conductive material. Thermal spreading across the modular panel can be achieved by splitting out the fluid channel into a fan of channels running throughout the modular panel. Thus, the thermal energy quickly diffuses across the modular panel to provide a substantially uniform temperature across the area of the modular panel.

In some embodiments of the present invention, the modular thermal emitters can be used as ceilings of interior space for space cooling.

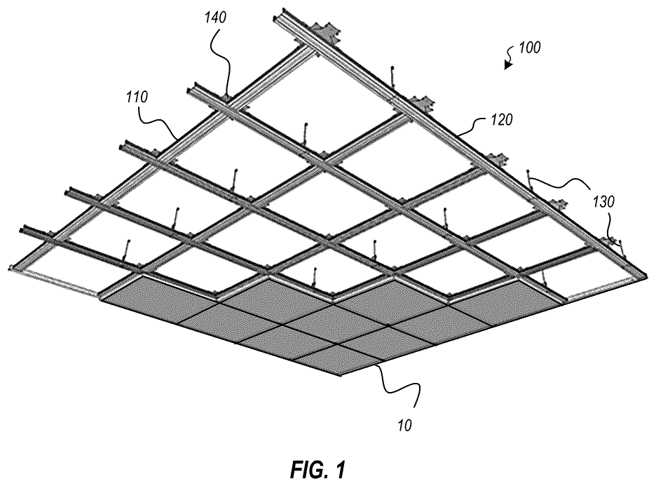

One will appreciate in light of the disclosure herein that the modular thermal emitters of one or more implementations can have various different useful applications. Referring now to FIG. 1, one such application will be described. In particular, FIG. 1 illustrates a plurality of modular thermal emitters 10 arranged in rows and columns within a suspended ceiling 100. The modular thermal emitters 10 provide heat transfer to heat or cool the room below the suspended ceiling by means of radiation and/or conduction large thermal mass. The modular thermal emitters 10 are supported by a support lattice or grid that includes a first set of rails 110, which are elongated support structures with their long dimension in a first direction, and the support lattice includes a second set of rails 110 having their long axis in another direction.

In the example illustrated in FIG. 1, the two sets of rails run perpendicular to each other, and the modular thermal emitters 10 are square or rectangular. However, other shapes and geometries can be used for the modular thermal emitters 10 and for the geometry of the support rails, For example, the suspended ceiling may have a chevron, diamond, herringbone, parquet, arabesque, fish scale, picket, or other pattern and geometry. All these and other geometries arc contemplated and are within the scope of the present disclosure.

The support rails 110 and 120 come together and can be joined at intersection point 140. The support rails 110 and 120 are suspended from a structural ceiling by suspension wires 130. In the non-limiting embodiment illustrates in FIG. 1, the suspension wires 130 attach to the second set of support rails 120, and the first set of support rails 110 are shorter than the second set of support rails 120, extending only between closest intersections points 140.

The modular thermal emitters 10 thus supported by the support lattice can transfer heat to/from a room below (i.e., the space below the suspended ceiling 100). Heat transfer is accomplished by changing the modular thermal emitters 10 above the room temperature to heat the room, and below the room temperature to cool the room. When used to cool the room, the modular thermal emitters 10 collect heat energy that is radiatively emitted from a room and/or heat energy transferred via convection or thermal conduction from the warmer air to the cooler modular thermal emitters 10. The collected energy can heat a thermal fluid (e.g., water) flowing through channels in the modular thermal emitters 10. When used to heat the room, the modular thermal emitters 10 transfer heat energy to a room via radiative heat transfer (e.g., emitting infrared radiation) and/or convection. The heat energy is transferred to the modular thermal emitters 10 from the thermal fluid flowing through channels in the modular thermal emitters 10.

Heat transfer occurs, at least in part, due to radiative heat transfer. Radiative heat transfer is a two-way process in which the room radiates electromagnetic energy, primarily in the infrared spectrum, to the modular thermal emitters 10, and the modular thermal emitters 10 radiates electromagnetic energy to the room. The difference between the amounts of energy radiated to and from the room determines whether the room is cooled or heated by the two-way radiative heat transfer process. The amount of radiative energy emitted by an object (e.g., the modular thermal emitters 10) is proportional to the object's absolute temperature (i.e., the temperature in Kelvin) raised to the fourth power (i.e., E=sT4, wherein E is the radiated energy, s is a constant that depends on the material properties, and T is the temperature in degrees Kelvin). An object that emits the most possible electromagnetic energy at a given temperature (i.e., has an emissivity of 100%) is referred to as a “black body.”

In practice, objects are neither perfect absorbers (i.e., have an albedo of 100%) nor perfect emitters (i.e., have an emissivity of 100%). The albedo and emissivity may in general be increased by applying coatings, pigments, or paints that make the surface of an object darker (e.g., anodizing or powder coating an aluminum surface to have a darker color). Nevertheless, for purposes of illustrating the principle of radiative heat transfer, the room and the modular thermal emitters 10 can be assumed to have identical emission and absorption properties (e.g., assume they are perfect emitters and absorbers). Then, the energy change (DE) of the room (i.e., the energy transferred to the room from the modular thermal emitters 10 minus the energy transferred from the room to the modular thermal emitters 10) will be approximately:

DE∝s(TP4−TR4)≈(4sTR3)DT,
wherein DE is the amount of heat transferred, TR is the temperature of the room, TP=TR+DT is the temperature of the modular thermal emitters 10, DT=TP−TR is the difference between temperature of the modular thermal emitters 10 (TP) and the temperature of the room (TR), and the final expression (−4sDT TR3) depends on the generally true assumption that the absolute value of DT is much less than the room temperature. This statement DE∝k DT (wherein k=4sTR3) effectively means that the heat transfer DE is proportional to the temperature difference DT, such that room is heated more quickly when the modular thermal emitters 10 have a greater temperature difference DT. And the room is cooled more quickly when the temperature difference DT is more negative.

In addition to the temperature difference DT, other factors affect radiative heat transfer, including the area of the modular thermal emitters 10 and the humidity of the air. For example, the heating and cooling are directly proportional to the area of the area A of the modular thermal emitters 10 (i.e., DE∝k×A×DT). To increase the radiative heat transfer, either the magnitude of the temperature difference DT can be increased, or the area A can be increase, or both. For example, the same amount of energy transfer can be achieved by lowering the temperature difference while increasing the area of the modular thermal emitters 10.

This is significant, especially for radiative cooling, because radiative heat transfer can become inefficient if the temperature of the modular thermal emitters 10 falls below the dew point temperature of the air. As discussed below, this issue can be addressed using a dehumidifier or other humidity control device to reduce the humidity. Even so, there are practical limits on how low the humidity can be reduced. Accordingly, it is preferable to achieve greater cooling through using modular thermal emitters 10 that have a large collective area, rather than relying on a large negative temperature difference. Previously, however, radiative heat transfer devices did not have large areas, preventing broad adoption of radiative heat transfer for radiative cooling applications. In contrast, the modular thermal emitters 10 can have a large area, making them effective for cooling applications requiring large amounts of heat transfer. That is, because the modular thermal emitters 10 enable larger radiative-heat-transfer areas than were previously practicable, the modular thermal emitters 10 increase the feasibility for radiative cooling for more applications.

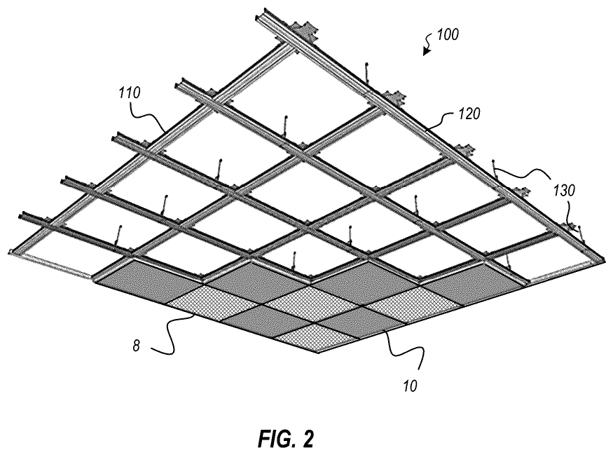

FIG. 2 illustrates an embodiment in which the modular thermal emitters 10 are interspersed with other emitters 8 (e.g., decorative emitters or acoustic ceiling tiles). For example, in certain applications, not as much heat transfer is required, and the density of the modular thermal emitters 10 can be reduced by having a certain percentage of tiles be modular thermal emitters 10 with the remainder of tiles being other emitters 8. A 50% density of the modular thermal emitters 10 can be realized by arranging other emitters 8 to occupy every second tile space, as illustrated in FIG. 2. Further, a room may be configured to have different densities of modular thermal emitters 10 in different parts of the room to account for non-uniform thermal sources and loads throughout the room. For example, in the northern hemisphere, more cooling may be required near southern facing windows to offset the solar heating from the sunlight coming through the windows.

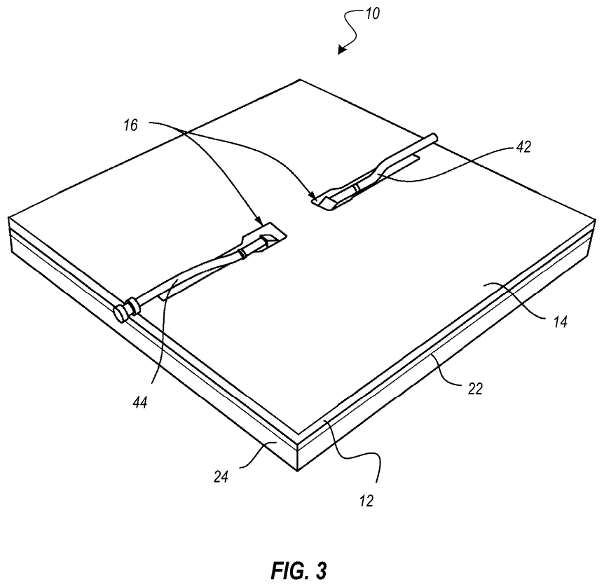

FIG. 3 illustrates a top view of a modular thermal panel 10. As shown by FIG. 3, the modular thermal modular thermal panel 10 can include an insulator panel 14 (e.g., a sheet of insulation) located on the top of the heat exchanger 12. In one or more implementations, the insulator panel 14 is attached to the heat exchanger 12 by friction, adhesive, mechanical attachment, over molding, or another form of attachment. In alternative implementations, the insulator panel 14 can simply reside under the heat exchanger 12.

The insulator panel 14 can comprise one or more insulating materials, such as, for example, polyfoam, expanded or extruded polystyrene, icynene, urethane, isocyanurate or rockwool. In one or more implementations, the insulator panel 14 can be impervious to water infiltration and insect infestation. The insulator panel can also provide rigidity to the heat exchanger 12. The thickness of the insulator panel 14 can vary depending upon the material and the location of use of the modular thermal panel 10. In any event, the insulator from the bottom of the heat exchanger 12. Thus, the insulator panel 14 can help keep thermal energy concentrated between the heat exchanger 12 and a face panel 24.

The face panel 24 can be a decorative panel, an acoustic tile, a ceiling tile, a ceramic tile, a wood panel, sheet metal, a metal sheet, a gypsum sheet, or other material used in residential, industrial, or commercial construction of walls or ceilings, for example.

The modular thermal panel 10 can also optionally include a membrane interface 22 on the bottom surface of the heat exchanger 12. The membrane interface 22 can comprise a sheet or layer of thermal conductive material placed between the heat exchanger 12 and the face panel 24. For example, the membrane interface 22 can comprise metal fibers or metal wool to form an acoustic absorbing layer while allowing for heat conductance between the heat exchanger and an acoustic tile.

The membrane interface 22 can fill gaps between the bottom surface of the heat exchanger 12 and the face panel 24 for the purpose of increasing the thermal transfer efficiency between the heat exchanger 12 and the face panel 24. In addition to the foregoing, the membrane interface 22 can reduce stress arising from differences in thermal expansion between the heat exchanger 12 and the face panel 24.

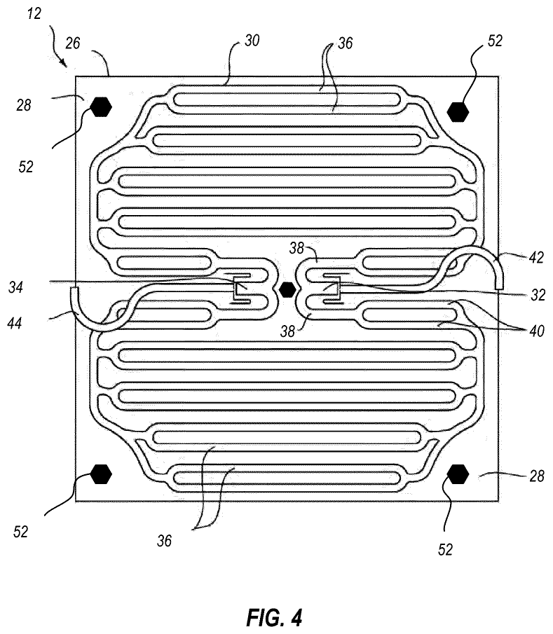

Referring now to FIG. 4, a bottom view of the heat exchanger 12 is illustrated. The heat exchanger 12 can generally be formed as a planar member that can include a first or bottom panel 26 and a second or top panel 28, which can be sheets of a thermally conductive material, such as molded thermoplastic or metal, for example. The heat exchanger can further include a plurality of channels 30 formed between the bottom panel 26 and the top panel 28. The bottom panel 26 and the top panel 28 can be bonded or otherwise attached to each other where they touch (e.g., regions other than the channels 30, 36, and 38). The bottom panel 26 and the top panel 28 of the heat exchanger 12 can comprise a thermally conductive or transmissive material including, but not limited to, polymers, stainless steel, aluminum, or copper. Furthermore, the heat exchanger 12 can include a powder coating to darken the color(s) of the heat exchanger 12 or to change thermal exchange rate of the heat exchanger 12 (e.g., by increasing the albedo, i.e., absorption of electromagnetic energy, and the emissivity, i.e., black-body transmission of electromagnetic energy).

In one or more implementations, the heat exchanger 12 can have a size and/or shape substantially the same as a face panel 24 (e.g., acoustic ceiling tile) to be placed on the heat exchanger 12. As shown by FIG. 4, the heat exchanger 12 can have a square shape. In alternative implementations, the heat exchanger 12 can have a circular, rectangular, oval, or other shape.

In one or more implementations, the heat exchanger 12 is a roll-bonded heat exchanger. In such implementations, the bottom panel 26 and the top panel 28 can define the channels 30. In particular, the second panel 28 can include the shape of the channels 30 stamped or otherwise formed therein. The portions of the second panel 28 that are not stamped can be bonded (i.e., roll-bonded) to the first panel 26. For example, as shown by FIG. 4 the portions of the second panel 28 between and surrounding the channels 30 are bonded to the first panel 26. Having channels 30 stamped only in the second or back panel 28 can allow the first or front panel 26 to have a flat, planar surface upon which the face panel 24 can rest. In alternative implementations, the first panel 26 can also include the shape of the channels 30 stamped or otherwise formed therein for increasing the fluid flow rate and lessening the pressure drop across the inlet and outlet.

As shown by FIG. 4, in certain embodiments, attachment points 52 may be arranged at various locations throughout the heat exchanger 12. In other, embodiments (e.g., when the heat exchanger 12 are supported along their perimeters as illustrated in FIGS. 1 and 2), the attachment points 52 may be omitted or unused. The attachment points 52 may be location at which fasteners may be applied to attach the heat exchanger 12 to a structural ceiling, to a wall, or to the face panel 24, for example. In certain embodiments fasteners—such as screws, bolts, nails, staples, lag bolts, eye bolts, or suspension wire—may be used to fix the heat exchanger 12 to a wall or ceiling. For example, when attaching the heat exchanger 12 to a wall, a sheet rock screw may be driven through the attachment points 52 to connect the heat exchanger 12 to the sheet rock of the wall. In another example, an eye bolt and a nut may be fixed to the attachment points 52 and a suspension wire may be used to suspend the heat exchanger 12 from the structural ceiling. The attachment points 52 may reinforced, molded structures within the bottom panel 26 and/or the top panel 28, and the attachment points 52 may a same material or different material as the bottom panel 26 and/or the top panel.

FIG. 4 further illustrates that the channels 30 can comprise an inlet 32 and an outlet 34. The inlet 32 and the outlet 34 each can each have a location spaced from the edges of the heat exchanger 12. For example, FIG. 4 illustrates an implementation in which both the inlet 32 and the outlet 34 are positioned at the center of the heat exchanger 12. A central location of both the inlet 32 and the outlet 34 can help ensure even distribution of heat and prevent one side or edge of the heat exchanger heating or cooling much faster than another side or edge. The central location of the inlet 32 and the outlet 34 can provide flexibility in connecting multiple heat exchangers 12 together.

The inlet 32 and the outlet 34 can each comprise main channels (e.g., larger diameter channels) that split into a plurality of branches (i.e., fractal channels 36). The fluid flowing through the channels 30 can enter the inlet 32 toward the center of the heat exchanger 12 flowing in a first direction. The direction of the fluid can then reverse and divide in half as the fluid flows through sub-channels 38. The fluid in each of the sub-channels 38 can then divide in half once again in secondary channels 40. After passing through the secondary channels 40, the direction of flow of the fluid can reverse again and the fluid can flow through the fractal channels 36 across the heat exchanger 12 in the same direction in which the fluid entered the inlet 32. The fluid can follow a similar, but opposite path, from the fractal channels 36 to the outlet 34.

As shown by FIG. 4, in one or more implementations the channels 30 can have a symmetrical layout across the middle of the heat exchanger 12. In alternative implementations, the channels 30 and fractal channels 36 can be asymmetrical. Still further the inlet and/or outlet can be positioned near an edge of the heat exchanger 12. Furthermore, the channels 30 can optionally have a serpentine configuration (i.e., a single channel that winds around the heat exchanger 12. One will appreciate that while the foregoing listed alternative implementations may provide some advantages, they may not be as efficient as the implementation illustrated in FIG. 4.

Thus, one will appreciate in light of the disclosure herein that the channels 30 of the heat exchanger 12 may not all have the same diameter. For example, the main channels of the inlet 32 and outlet 34 can have a diameter larger than that of the sub-channels 38. The sub-channels 38 in turn can have a larger diameter than the secondary channels 40 and the fractal channels 36. In one or more implementations, the diameter of the main channels of the inlet 32 and outlet 34 is twice as large as the diameter of the sub-channels 38, which in turn have a diameter that is twice as large as the fractal channels 36. In alternative implementations, all the channels 30 have substantially the same diameter.

The channels 30 (and any tubes attached thereto) of the heat exchanger 12 can have a cross-section or shape that will allow for an efficient flow of fluid through the heat exchanger 12. For example, the channels 30 can have, but are not limited to, a D shape, half-circular shape, triangular shape, circular or round shape, a or semicircular shape. In at least one implementation the channels 30 have a circular cross-sectional shape.

FIG. 4 further illustrates that the heat exchanger 12 can further include an inlet tube 42 and an outlet tube 44. The inlet tube 42 and outlet tube 44 can feed and take heat exchange fluid to and from the heat exchanger 12. The heat exchange fluid can comprise, but is not limited to, water, ethylene glycol, or another suitable fluid for the purpose of transferring thermal energy into or out of adjoining thermal emitters. When metal is used to manufacture the modular thermal emitters 10, a closed loop system for the transfer of thermal energy to or from a potable water system may be used. The heat exchange fluid may, but is not required to have, anti-corrosion properties. The heat exchange fluid can comprise an anti-freeze solution such as glycol, but not limited thereto.

In at least one implementation the inlet and outlet tubes 42, 44 can each have a curved configuration as shown in FIG. 4. The curved or bent configuration can provide more flexibility and adjustability in the connection between panel units. In at least one implementation, the inlet and outlet tubes 42, 44 are bent such that the opposing ends of the inlet and outlet tubes 42, 44 (i.e., the ends not connected to the heat exchanger 12) are oriented at approximately 90 degrees relative to the inlet 32 and outlet 34 of the heat exchanger 12. In alternative implementations, the inlet and outlet tubes 42, 44 are straight or flexible.

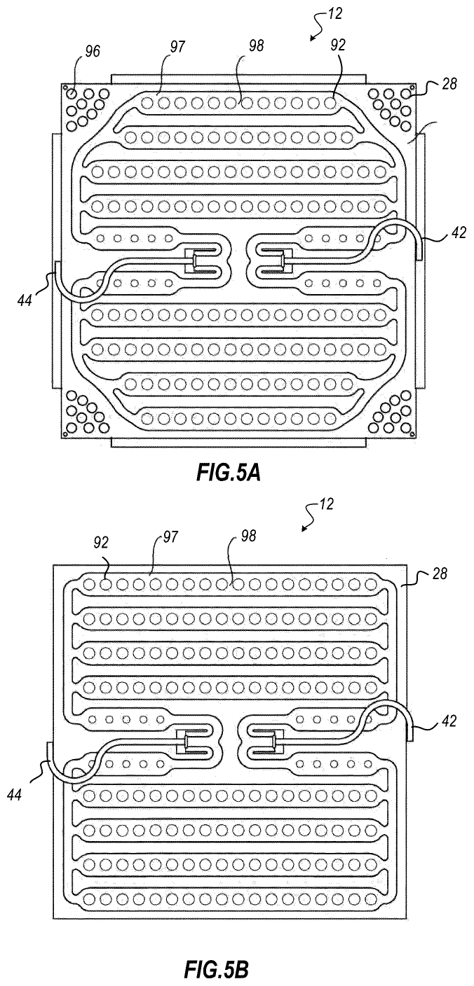

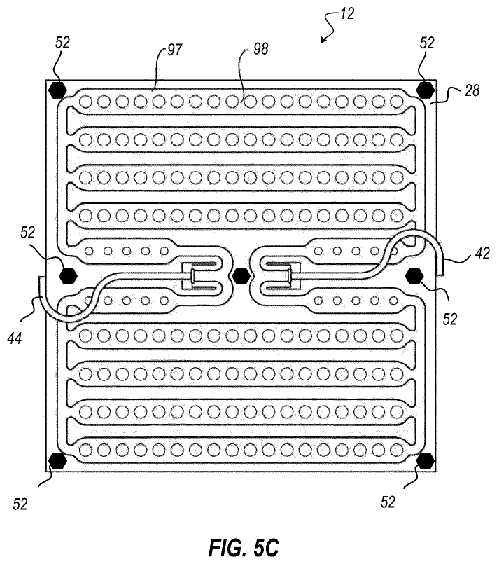

FIGS. 5A, 5B, and 5C further illustrate additional implementations of a heat exchanger 12 similar to that of FIG. 4. For example, in FIG. 5A, the heat exchanger 12 includes raised support elements 96 that provide support for the thermal mass unit in areas where there are no raised channels 30 to provide support. These raised support elements 96 can have a bottom surface equal in elevation to the bottom surface of the raised channels 30. The raised support elements 96 can protrude on the second panel 28. FIGS. 5A, 5B, and 5C further illustrate that the sub channels 97 can be connected with cross channels 98 to create a balancing effect between the channels and to create turbulent flow adding to the efficient transfer of thermal energy between the thermal transfer fluid and the channel walls.

The sub channels 97 (also referred to as branches) can include turbulators 92 that disrupt laminar flow and cause mixing of the heat exchange fluid, resulting in a higher rate of heat transfer through the channel walls. For example, the turbulators 92 can be obstructions within the channel as shown in FIGS. 5A and 5B. These obstructions may be off-center within the channels to avoid the formation of stagnant pockets of entrained air behind the obstructions, which occur when the flow around the obstructions is symmetric. The turbulators 92 may be obstructions that are shaped to prevent symmetric flow around the turbulators 92. Additionally, or alternatively, the turbulators 92 can include shaping the channel to disrupt laminar flow (e.g., making the channel sides non-smooth, jagged, or wavy).

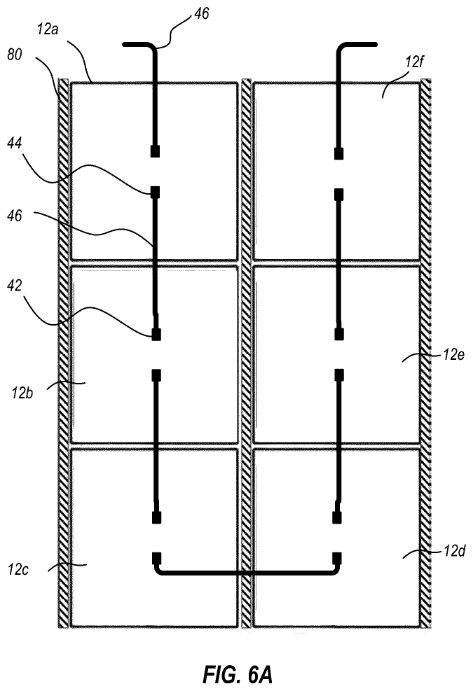

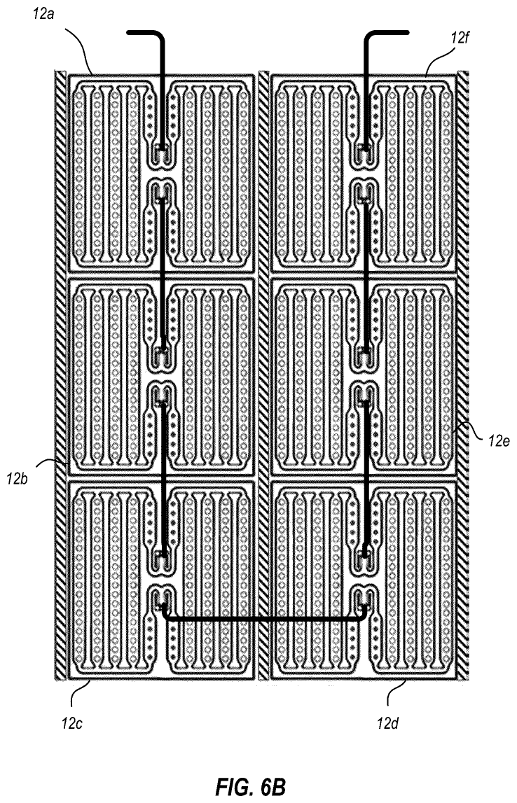

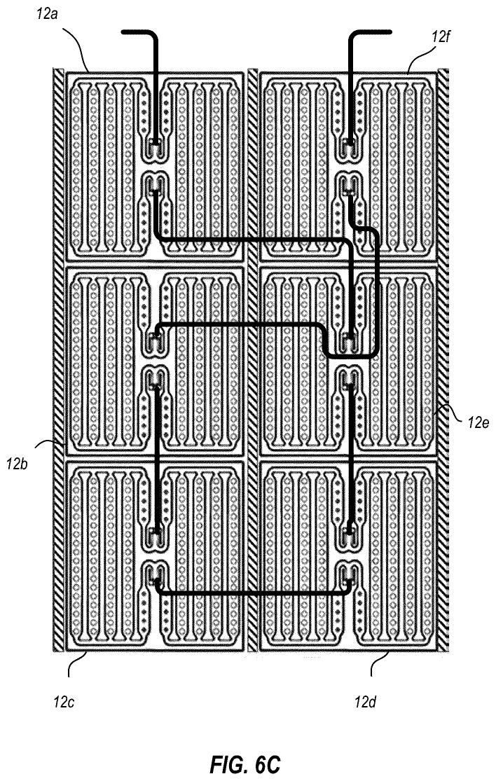

The inlet and outlet tubes 42, 44 can allow one to connect multiple modular thermal emitters 10 together. For example, FIGS. 6A, 6B and 62 illustrate an array of six modular thermal emitters 10 (i.e., heat exchangers 12a, 12b, 12c, 12d, 12e, and 12f). Thus, individual modular thermal emitters 10 can create rows of the modular thermal emitters 10. One will appreciate that the modularity (e.g., size, connect ability) can allow for arrays with any number of different configurations. Further, the rows can couple to supply and return tubes via a manifold, to form an array. The supply and return tubes may route and attach to an object, such as but not limited to a heat exchanger, a water heater, chiller, geothermal loop, solar panel, swimming pool circulation loop, fountain, boiler, under water pipe loop or septic system loop.

In FIG. 6A, an outlet tube 44 of heat exchangers 12a is coupled to an inlet tube 42 of the adjacent heat exchangers 12a. More specifically, tubing 46 can couple the inlet and outlet tubes 42, 44 together. The tubing 46 can be fusion welded to the tubes 42, 44 to eliminate mechanical connections between the heat exchangers 12a, 12b, 12c, 12d, 12e, and 12f. This reduces the number of possible failure/leak points. Further, fusion welding reduces wear and aging effects due to friction and differing rates of thermal expansion between different materials. Alternatively, the tubing can be joined using a union connector, a friction-fit connector, a soldered connector, a brazed connector, or a welded connector. In one or more implementations, the connector can allow for the disassembly of modular thermal emitters 10, without causing damage to the inlet and outlet tubes 42, 44.

In alternative implementation, such as when used with permanent, well supported applications the tubing can be joined using another type of connector. The connectors can comprise materials such as, but not limited to, plastic, brass, stainless steel, bronze, copper, rubber. In at least one implementation, the connector can comprise plastic due to its low cost and resistance to corrosion. The O-rings may comprise a material suitable to the intended temperature range, chemical exposure, and life expectancy for each application. In one or more implementations, the connector is a one piece unit with a thermoplastic elastomer in place of an O-ring to create a waterproof seal.

In FIG. 6A, the array of modular thermal emitters 10 are held in place by a support system 80. Additionally or alternatively, the modular thermal emitters 10 may also be connected together along touching edges of the modular thermal emitters 10 to form groups of modular thermal emitters 10. The support system 80 may be a U-shaped trough into which a group of preconnected modular thermal emitters 10 is inserted to attach the modular thermal emitters 10 to a ceiling or a wall. As another example, the support system 80 may be part of a suspended ceiling support lattice such as illustrated in FIG. 1, and the modular thermal emitters 10 may be assembled by placing them within the suspended ceiling support lattice.

Further, the modular thermal emitters 10 may be reconfigurable, and may be configured to accomplish a particular objective. For example, FIG. 6B illustrates a case in which the tubing 46 is configured to minimize a length of the tubing 46 by connecting a current heat exchanger (e.g., heat exchanger 12a) to a next closest heat exchanger (e.g., heat exchanger 12b) that is the closest heat exchanger that is not already connected to the array of heat exchangers.

FIG. 6C illustrates a case in which heat exchanger 12a connects to heat exchanger 12e, which then connects to heat exchanger 12d, and so forth. This configuration might be used to provide more even heating/cooling because upstream heat exchangers provide more heat transfer than downstream heat exchangers. That is, the thermal fluid temperature changes as it propagates through the respective heat exchangers, and the temperature of the thermal fluid becomes closer to room temperature for the downstream heat exchangers, resulting in less heating/cooling at the downstream heat exchangers. Thus, arranging the heat exchangers such that the upstream heat exchangers are not clumped together on one side with the downstream heat exchangers clumped together on the other side can provide more even heat transfer.

For example, when radiative cooling, the temperature of thermal exchange fluid increases as it flows through the respective heat exchangers. The configuration in FIG. 6C ensures that both the left and right sides of the array of heat exchangers provide approximately equal heat transfer, whereas in the configuration in FIG. 6B all the upstream heat exchangers are on the left side of the array and would provide more heat transfer than the downstream heat exchangers on the right side of the array. Sometimes more heat transfer on the left side might be desirable, as might be the case if the left side was next to south facing windows, resulting in greater solar heating.

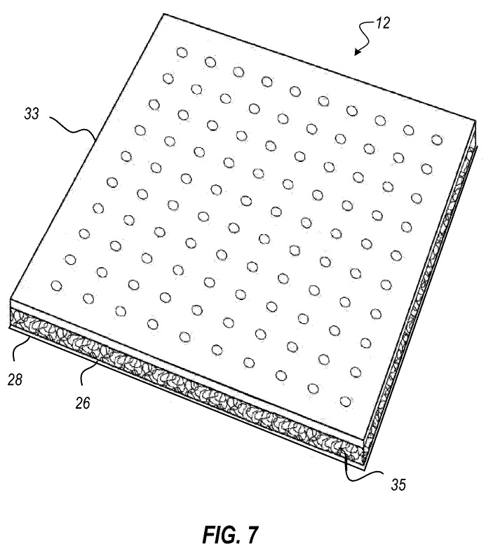

In still further implementations, the heat exchanger 12 can comprise a third panel 33 in addition to the first panel 26 and the second panel 28. For example, FIG. 7 illustrates a heat exchanger 12 configured with an acoustic ceiling tile. The third panel 33 can comprise a decorative panel to provide the heat exchanger 12 with a desirable aesthetic. The third panel 33 can couple to the bottom of the first panel 26 by crimping, fasteners, a tongue and groove configuration, a snap-fit configuration, gravity, friction, an adhesive, or other fastening mechanism. The heat exchanger 12 can further include a thermally conductive material 35 between the first panel 26 and the third panel 33. The thermally conductive material 35 can comprise, for example, metallic beads, or woven metallic material. The thermally conductive material 35 can be a sound dampening material that acts to absorb sound. In implementations in which the channels are stamped in the first panel 26, the third panel 33 can provide a flat, planar surface upon which a face panel 24 can rest or be attached. One will appreciate that a heat exchanger 12 configured as a ceiling panel can provide a highly efficient way to heat and cool spaces.

FIG. 7 illustrates a bottom perspective view of an example of a modular thermal panel having a decorative face/panel and conductive intermediary layer, according to an implementation of the present invention.

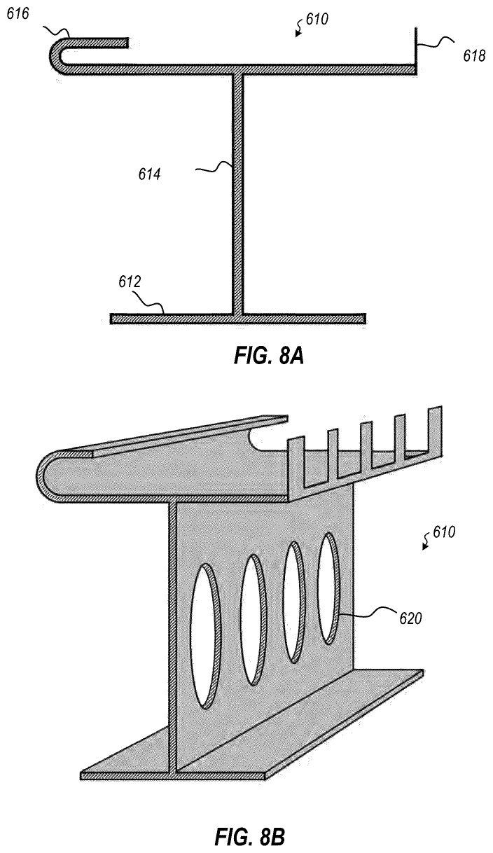

FIGS. 8A and 8B illustrate a connector 610 that connects the modular thermal emitters 10 to a support lattice for a suspended ceiling. FIG. 8A illustrates a cross section of the connector 610, and FIG. 8B illustrates a perspective of the connector 610. The connector 610 has a cross section with a lower portion having an inverter T-shape, and an upper portion that is shaped to connect to the support lattice for the suspended ceiling, including a hook portion 616 that extend around one end of the support lattice for a suspended ceiling and a tab 618 the folds over another end of the support lattice.

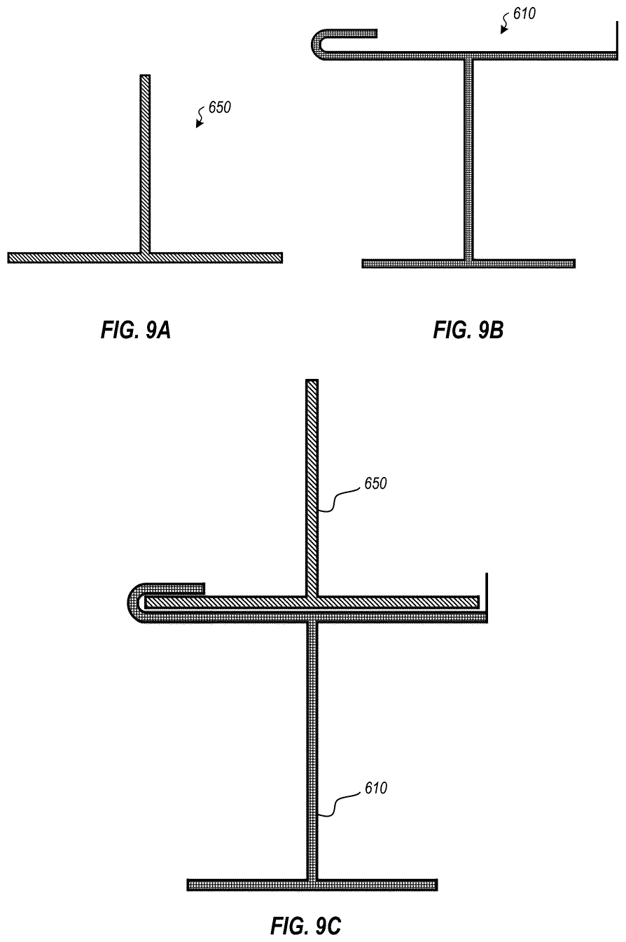

FIGS. 9A, 9B, and 9C illustrate a non-limiting example of the upper portion of the connector 610 attaching to a support lattice 650 having an inverted T-shape. FIG. 9A illustrates a cross section of the support lattice 650. FIG. 9B illustrates a cross section of the connector 610. FIG. 9C illustrates how the hook portion 616 of the connector 610 slides on to one end of the support lattice 650. After which, the tab 618 of the connector 610 can be folded over the other end of the support lattice 650.

Returning to FIGS. 8A and 8B, FIG. 8B also illustrates through holes 620 in the connector 610, which can be used to attach suspension wires to suspend the connector 610 to a structural ceiling, for example. In FIG. 8A, an upright portion 614 of the inverted T-shape connects the upper portion of the connector 610 to a horizontal portion 612 of the inverted T-shape. The horizontal portion 612 supports the modular thermal emitters 10 from below, and gravity's downward force presses the modular thermal emitters 10 against the horizontal portion 612. At times the downward force due to gravity is insufficient to keep the thermal emitters 10 in place. For example, negative pressure in the room can cause an upward force on the modular thermal emitters 10. Accordingly, the connector 610 may include anti-uplift clips to prevent upward movement of the modular thermal emitters 10.

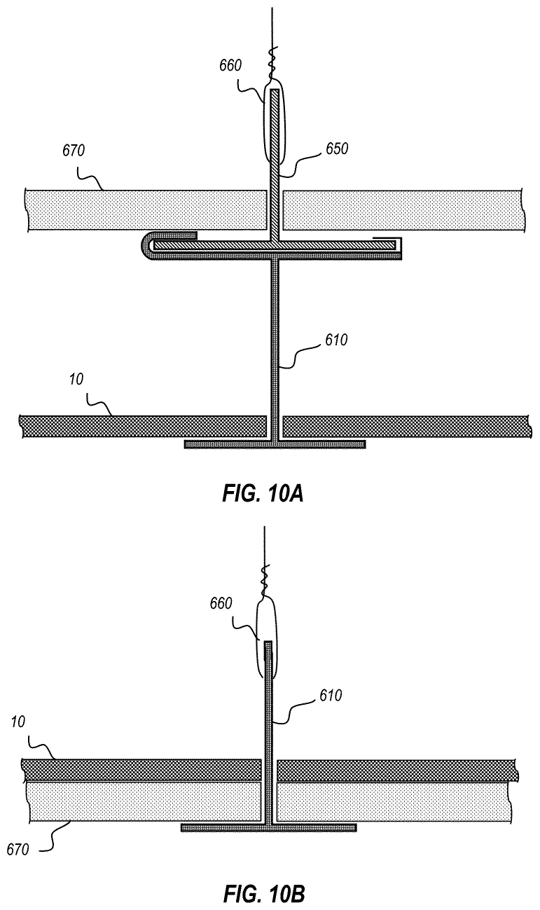

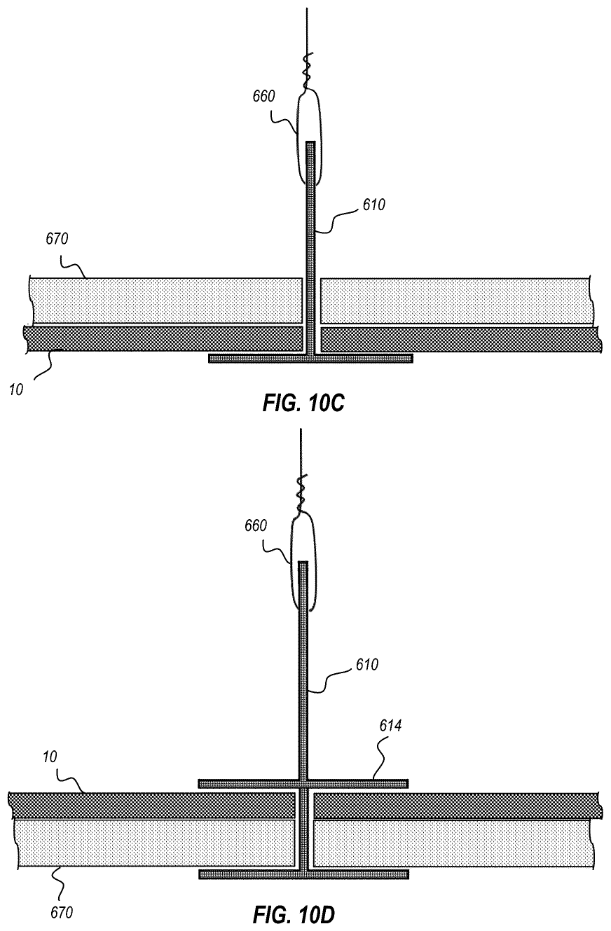

FIGS. 10A, 10B, 10C, and 10D illustrate example embodiments of the connector 610 supporting modular thermal emitters 10. In these example embodiments, the modular thermal emitters 10 are arranged in a suspended ceiling. In FIG. 10A, a suspension wire 660 is attached to a support lattice 650, and the connector 610 attaches to the support lattice 650. Modular thermal emitters 10 are supported by the connector 610, and ceiling tiles 670 are supported by the support lattice 650.

In FIG. 10B, a suspension wire 660 is attached to the connector 610, and an upper portion of the connector 610 does not include the attachment structure for attaching to a support lattice 650. The ceiling tiles 670 are supported by the connector 610, and the modular thermal emitters 10 are supported by the ceiling tiles 670. In certain embodiments, the modular thermal emitters 10 may be integrated with the ceiling tiles 670, and the integrated units may be referred to as modular thermal emitters 10.

In FIG. 10C, a suspension wire 660 is attached to the connector 610, and an upper portion of the connector 610 does not include the attachment structure for attaching to a support lattice 650. The modular thermal emitters 10 are supported by the connector 610, and the ceiling tiles 670 are supported by the modular thermal emitters 10. In certain embodiments the ceiling tiles 670 may be insulators emitters, and the insulators emitters may be integrated with the ceiling tiles 670, and the integrated units may be referred to as modular thermal emitters 10.

FIG. 10D illustrates a similar configuration to FIG. 10B, except a second horizontal portion 614 is arranged above the modular thermal emitters 10, providing a U-shaped trough into which the modular thermal emitters 10 and ceiling tiles 670 are inserted. The U-shaped trough helps to prevent uplift when a room is subject to a negative pressure.

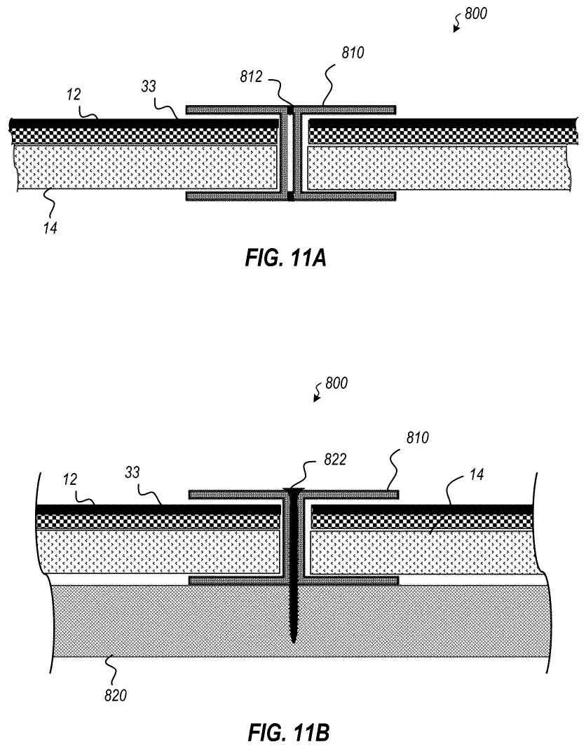

FIGS. 11A and 11B illustrate an implementation for embodiments 800 in which the modular thermal emitters 10 are installed/attached to a wall. In the non-limiting implementation of FIGS. 11A and 11B, U-shaped troughs are tack welded back-to-back at points 812 to make an H-shaped support structure 810. The support structure 810 are arranged to hold a combination of a decorative panel 33, a heat exchanger 12, and an insulator panel 14. FIG. 11B illustrates a fastener 822, such as a dry wall screw, fastening the support structure 810 to a structural wall 820 (e.g., framing members in a wall, sheetrock, or a sheet of gypsum drywall).

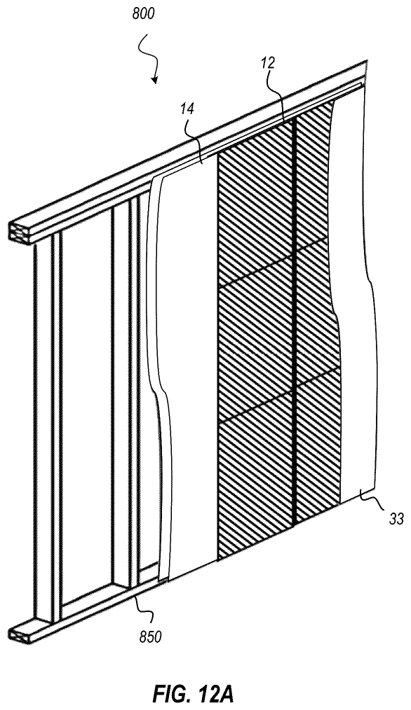

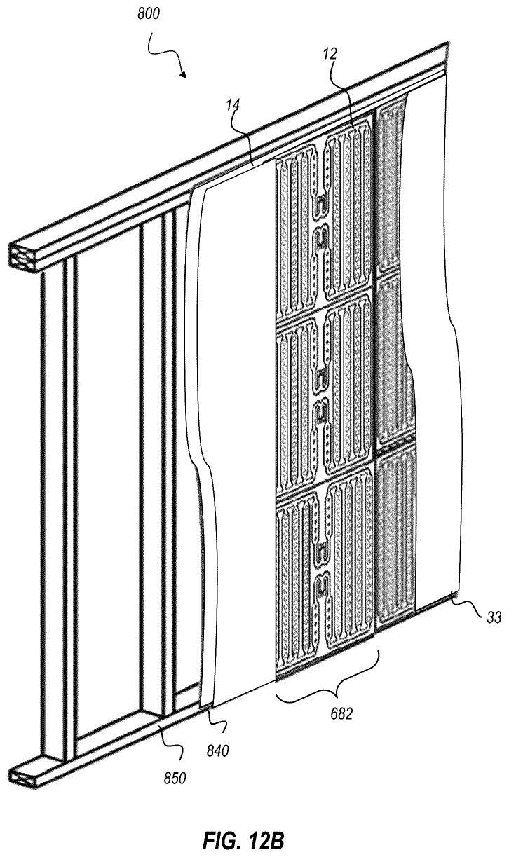

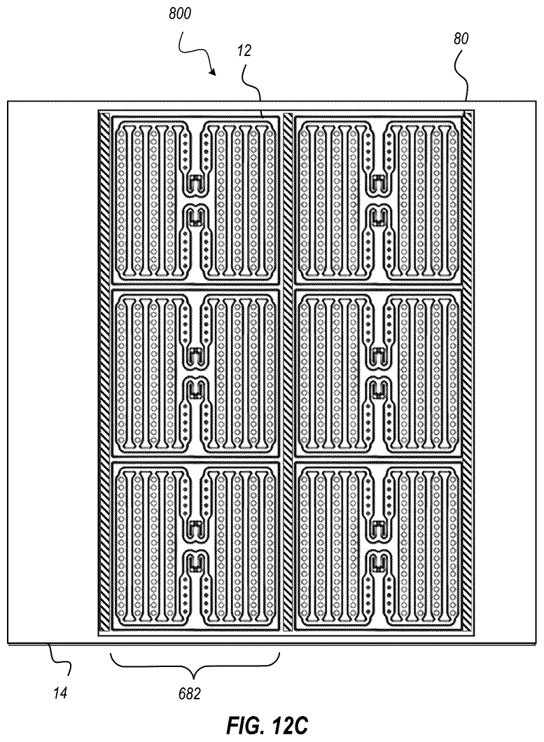

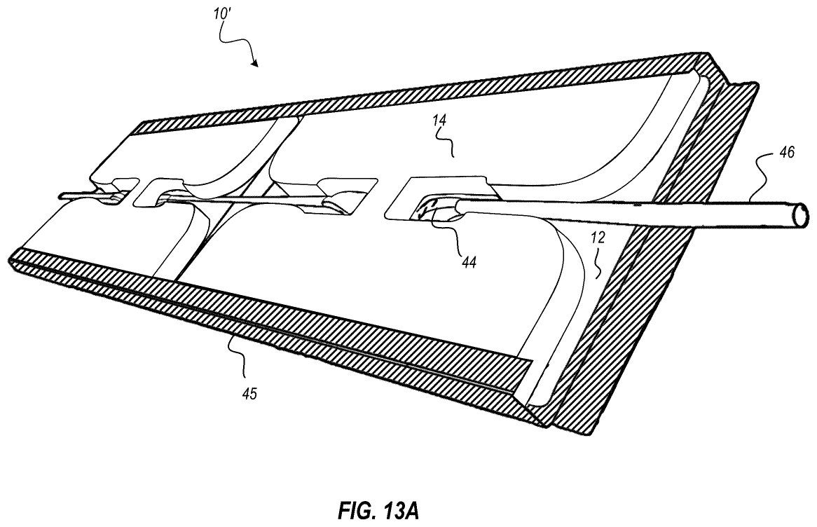

FIGS. 12A and 12B illustrate perspective views of the modular thermal emitters 10 being configured with wall structure 800. The wall structure 800 includes framing members 850 (e.g., two-by-four wood beams), a decorative panel 33, a heat exchanger 12, and an insulator panel 14. For example, fasteners located at reinforced attachment points 52 can be used to attach the heat exchanger 12 to the framing members 850. Although FIGS. 12A and 12B illustrate a wall embodiment, a ceiling may also include framing members 850, and a similar configuration may be used to attach the heat exchanger 12 to the framing members 850 in a ceiling.

FIG. 12B illustrates an embodiment that includes a frame wall 840 next to the framing members 850, then an insulator panel 14 is arranged on the frame wall 840 (e.g., plywood, fiberboard, or gypsum emitters). The fasteners may be used to attach the heat exchangers 12 to either the framing members 850 or the frame wall 840, for example. The decorative panel 33 may be sheet rock, ceramic tile, wood tile, wood emitters, or another building material, such as those used for interior residential, industrial, or commercial buildings.

FIG. 12C illustrates an array 682 of heat exchangers 12. The heat exchangers 12 in an array 682 may have been previously attached to each other along an edge, such that the array 682 may be installed as a single unit. Further, the tubing 46 between the respective heat exchangers 12 may be fusion welded, which has the advantage of removing mechanical connections (i.e., potential failure/leak points) between the heat exchangers 12. The array 682 may be attached to the wall using a trough support system 80 into which the array 682 is inserted as a single unit. FIG. 12C illustrates a front view of the embodiment in which the array 682 may be attached to the wall using a trough support system 80. The decorative panel 33 is not shown to better seen the heat exchangers 12 and the trough support system 80.

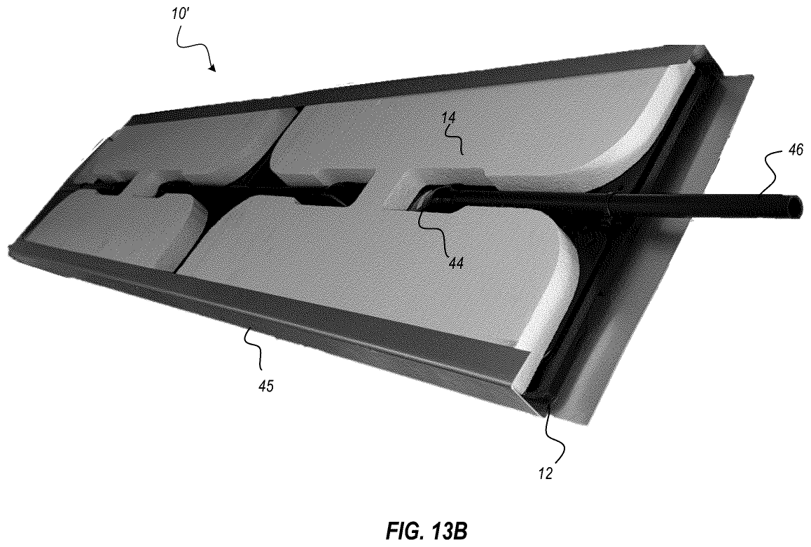

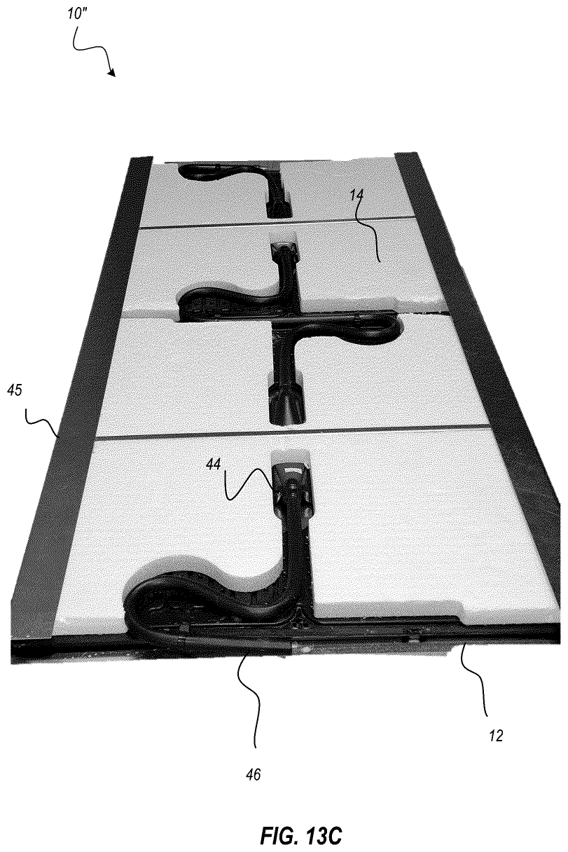

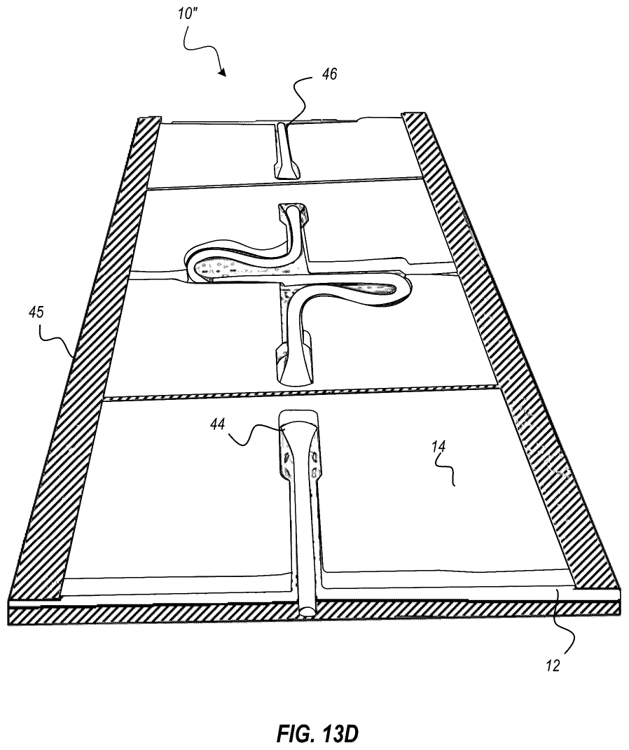

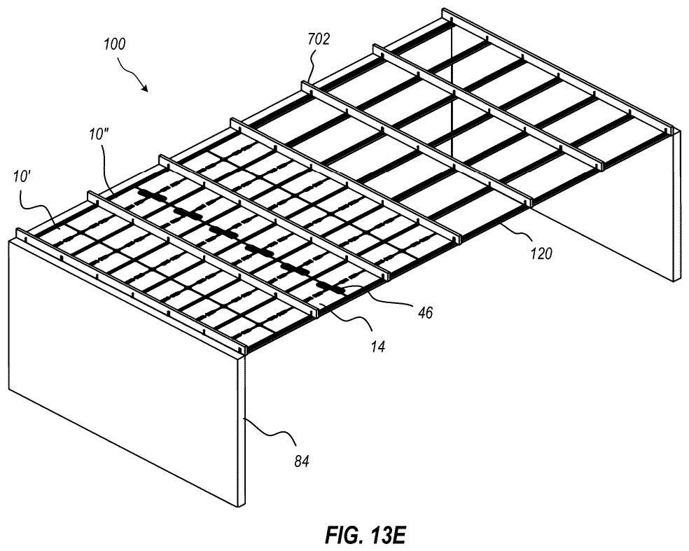

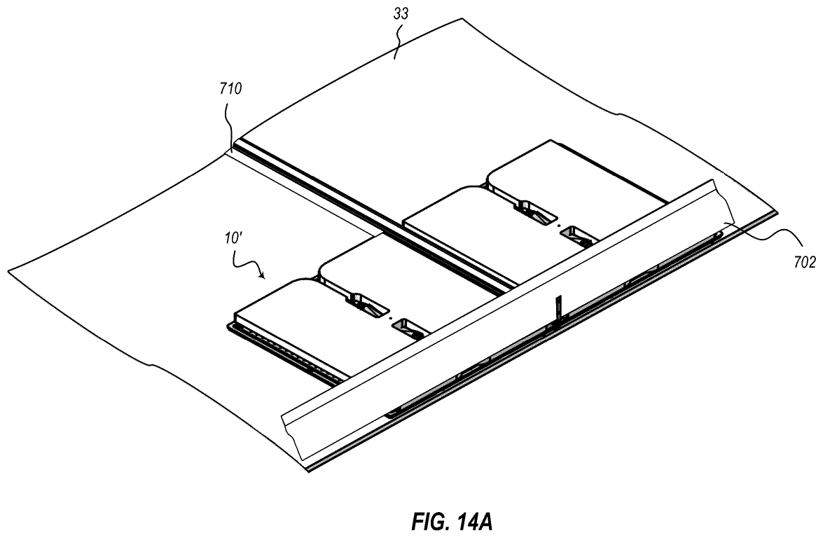

FIGS. 13A, 13B, 13C, and 13D illustrate an embodiment in which an outer panel 45 is sheet metal that has been shaped to fold around heat exchangers 12, and insulator panels 14 are arranged on a back side of the heat exchangers 12. The insulator panels 14 include cutouts shaped to accommodate the tubing 46 that provides fluid communication between the heat exchangers 12. In the thermal emitters 10′ that are illustrated in FIGS. 13A and 13B, the cutouts in the insulator panels 14 are shaped to accommodate tubing 46 arranged in a straight line between the heat exchangers 12. In the thermal emitters 10″ that are illustrated in FIGS. 13C and 13D, the cutouts in the insulator panels 14 are shaped to accommodate tubing 46 arranged in a curved path between the heat exchangers 12. The outer panel 45 can be sheet metal, for example. As illustrated in the figures, the outer panel 45 can be shaped to bend around an edge of the insulator panels 14 and hold together the ensemble of the outer panel 45, heat exchangers 12, and insulator panels 14. The outer panel 45 may then be fastened to a wall or a ceiling. For example, fasteners may be driven through the sheet metal of the outer panel 45. Additionally, the outer panel 45 may be fastened to an object within a building, such as a support column, a shelf, a desk, or furniture within the room.

As depicted, heat exchanger 12 can be placed adjacent to an outer panel 45. The heat exchanger 12 may be made of thermally conductive material including polymers, steel, aluminum, or copper. Inlet tube 42 and outlet tube 44 are coupled to heat exchanger 12 for conveying the thermal fluid (e.g., water) in to and out from the heat exchanger 12.

To prevent parasitic heat exchange with the plenum space, for example. In some embodiments, insulation 14 can be partially precut to allow space for the tubing 46. In addition, a thermal-conductive membrane can be placed between heat exchanger 12 and the outer panel 45 to provide good thermal contact and alleviate stresses arising from thermal expansion and contraction.

As discussed above, the modular thermal panel 10 may include multiple fractal channels formed in heat exchanger 12 allowing heat exchange fluid to pass through. Fractal channels may include a main channel coupled to inlet tube 42 and multiple sub channels split from the main channel. The sub channels may converge and form a second main channel coupled to outlet tube 44. In certain embodiments, fractal channels only create bulges on bottom side of heat exchanger 106, such that a top side is flat and has maximum surface contact with an outer panel 45 that has a flat surface.

To provide flexibility in connecting the heat exchangers 12 together, the inlet tube 43 and outlet tube 44 may be coupled substantially close to the center part of heat changer 12 and may be curved in a shape to connect to an adjacent heat exchange.

In certain embodiments, the heat exchangers 12 may be joined together using thermoforming to generate heat exchange components and emitters. Additionally, or alternatively, the heat exchangers 12 may be joined together using roll bonding for connecting heat exchange components and emitters. When the heat exchange components and emitters are both made of high purity aluminum and high pressure is applied, the emitters and heat exchange components are bonded together except for the area printed with the layout pattern. High-pressure air can then be transited to the non-bonded area and creates channels inside the heat exchangers.

In some embodiments, the tubing 46, inlet tube 42, outlet tube 44, and the heat exchangers 12 may be connected using fusion welding or another process to create modular bonds between the respective components.

In some embodiments, the heat exchangers 12 may be painted (e.g., powder coating), making the heat exchangers a dark color to improve a thermal exchange rate.

As discussed more below, one or more pumps integrated with a microprocessor may be further connected to the heat exchangers. The user of the system can preset a target temperature range. The microprocessor first measures a temperature differential between inlet tube and outlet tube and turns on the pumps when the temperature differential falls inside the target temperature range. When the temperature differential falls outside the target temperature range, the microprocessor turns off the pump.

FIG. 13E illustrates an example of the modular thermal emitters 10′, which are illustrated in FIGS. 13A and 13B, and the modular thermal emitters 10″, which are illustrated in FIGS. 13C and 13D, being arranged in a ceiling 100. Ceiling studs/beams 702 form a part of a structure of the ceiling and rails 120 are fixed to the studs/beams 702. The modular thermal emitters 10′ and 10″ are fixed to the rails 120, and the ceiling is supported, for example, by walls 84.

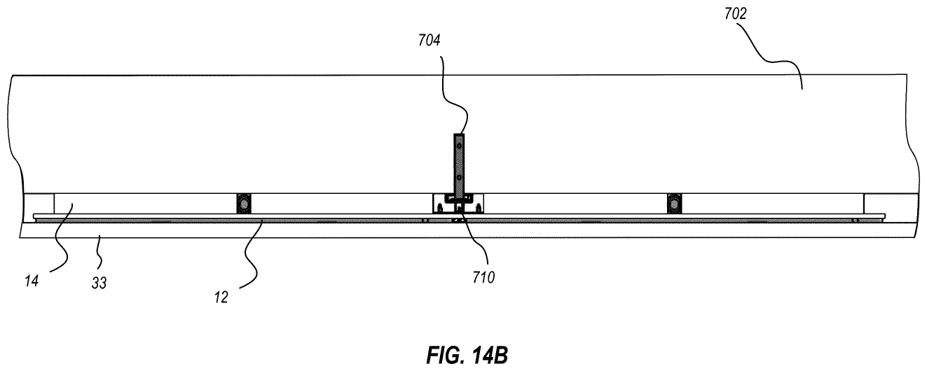

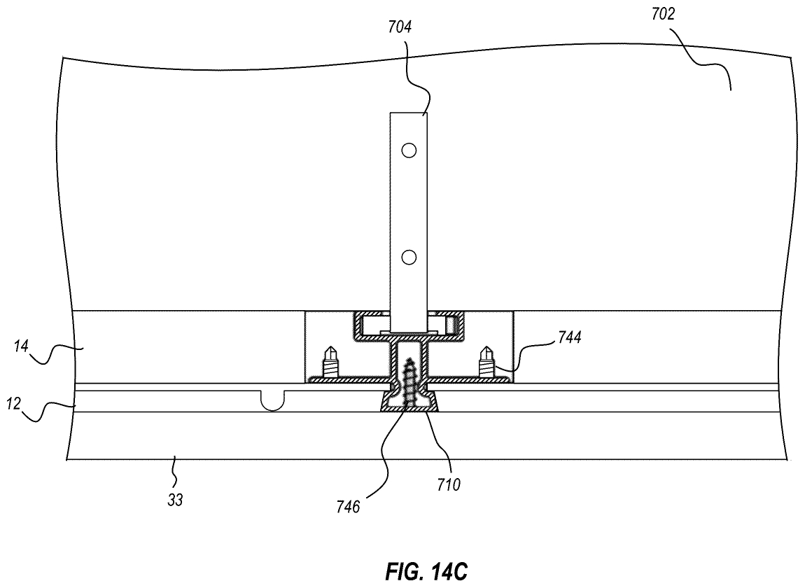

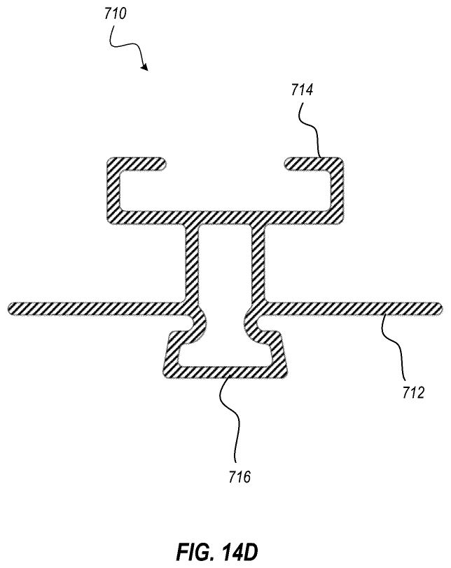

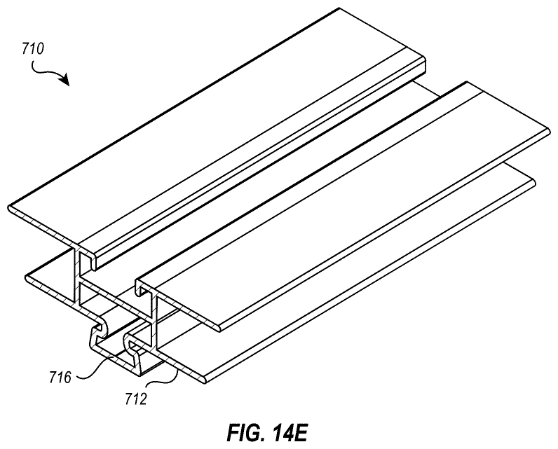

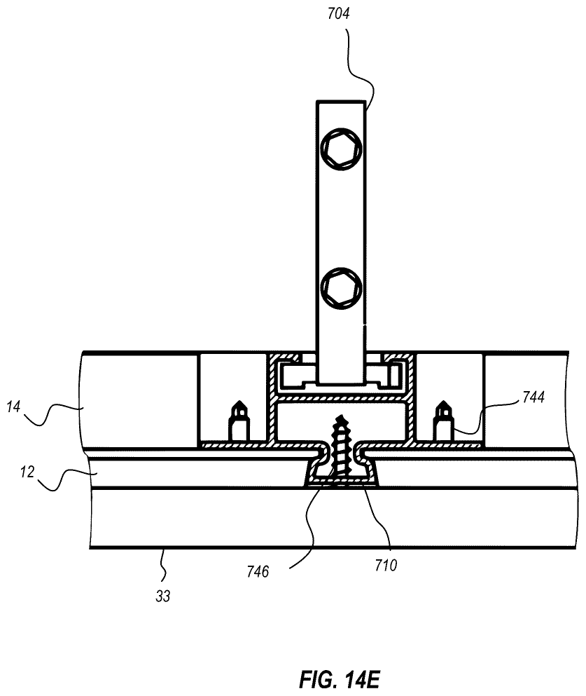

FIGS. 14A, 14B, 14C, 14D, and 14E illustrate an embodiment in which an inverted T-shaped support rail 710 functions as the rail 120. A hanging strap 704 fixes the support rail 710 to the beam 702. Fasteners 744 fix the modular thermal emitters 10′ and 10″ to the support rail 710. The modular thermal emitters 10′ and 10″ include a heat exchanger 12 and an insulator panel 14. A fastener 746 fixes a decorative panel 33 to the support rail 710.

FIG. 14D illustrates an example in which a Therma-Hexx™ strut is the support rail 710. The support rail 710 includes lip portion 714 that is used to connect the support rail 710 to a structure of the ceiling. The support rail 710 includes a horizontal portion 712 that connects one or more modular thermal emitters 10 to the support rail 710. The support rail 710 includes a bottom portion 716. In certain embodiments the bottom portion 716 can be used to connect additional panels, such as a decorative panel 33, to the support rail 710.

FIG. 14F is a side view of an example having a support rail 710 fastened with a fastener 746 to an insulator panel 14, a heat exchanger 12, and a decorative panel 33 according to the present invention.

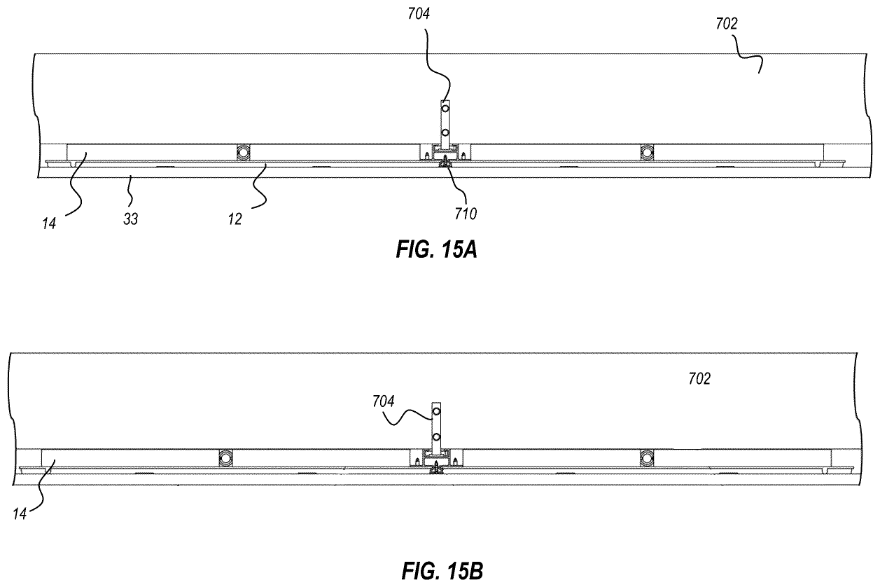

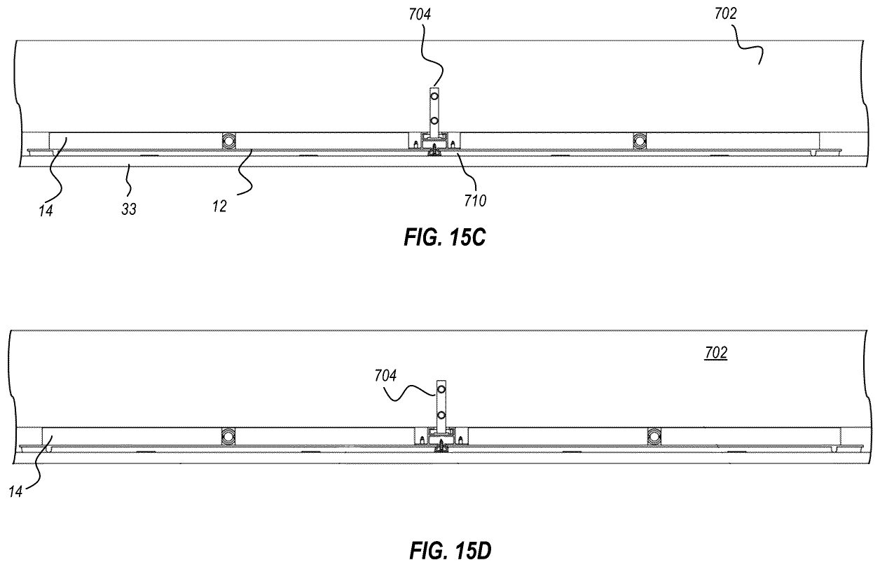

FIGS. 15A, 15B, 15C, and 15D illustrate an embodiment in which a Therma-Hexx™ strut functions as the rail 120. A hanging strap 704 fixes the Therma-Hexx™ strut 710 to the beam 702, which can be a wood joist. Screws fix the heat exchanger 12 the Therma-Hexx™ strut 710. For example, a modular thermal emitter 10 can include a heat exchanger 12 and an insulator panel 14. Another screw fixes a decorative panel 33 (e.g., drywall) to the Therma-Hexx™ strut 710.

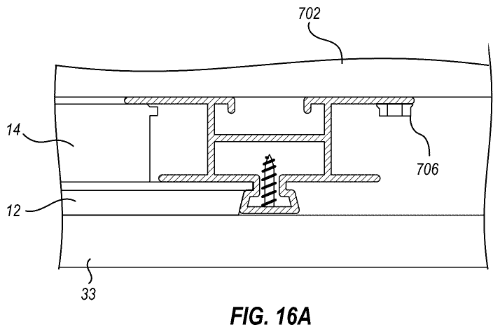

FIGS. 16A and 16B illustrate an embodiment in which a Therma-Hexx™ strut functions as the rail 120. A bolt 706 fixes the Therma-Hexx™ strut 710 to the beam 702, which can be a wood joist. Screws fix the heat exchanger 12 the Therma-Hexx™ strut 710.

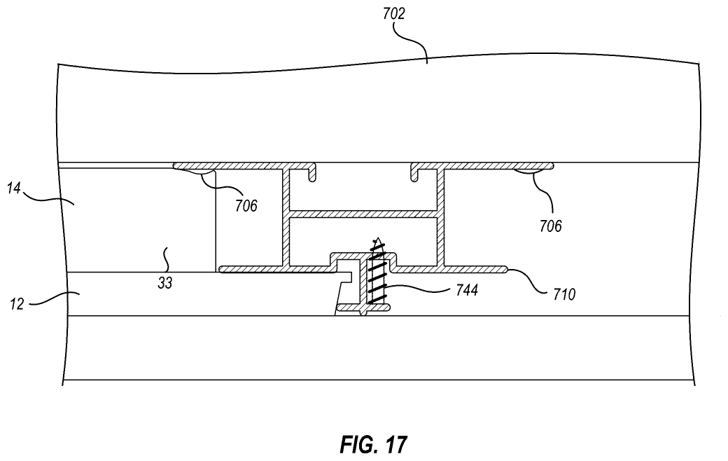

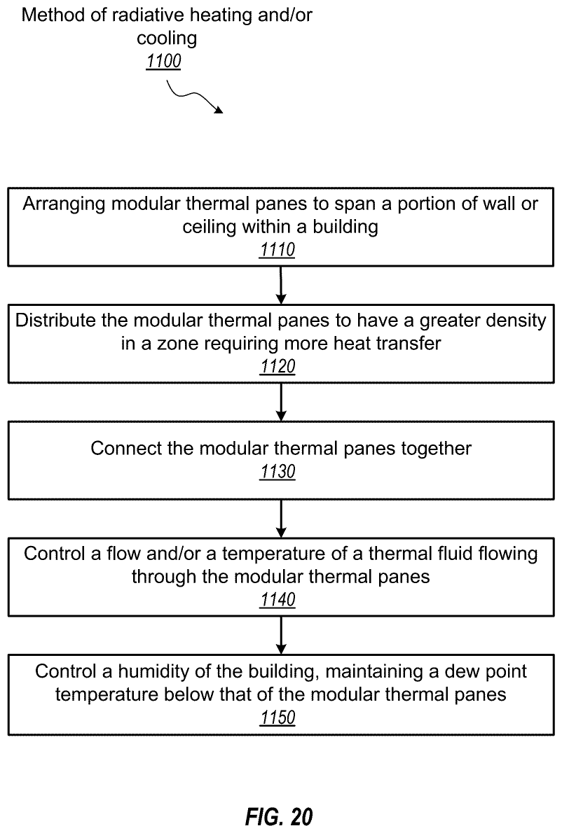

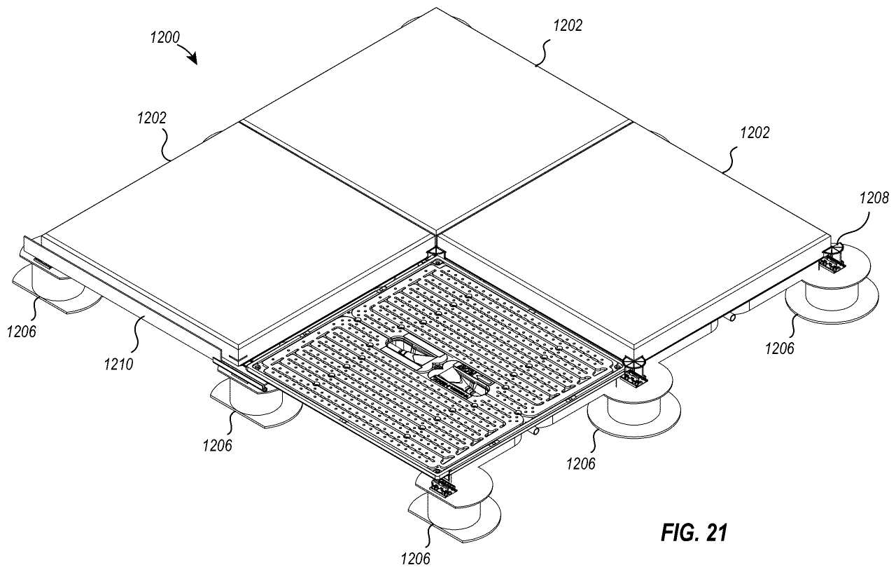

FIG. 17 illustrates an embodiment in which a strut functions as the rail 120. Fasteners 706 fix the strut 710 to the beam 702, which can be a wood joist. Another fastener fixes a decorative panel 33 (e.g., drywall) to the strut 710. A heat exchanger 12 is suspended above the decorative panel 33 and below the beam 702 and the insulator panel 14. The strut 710 in FIG. 21 has a different shape than the strut 710 in FIGS. 20A and 20B. Different shapes can be used for the strut 710.

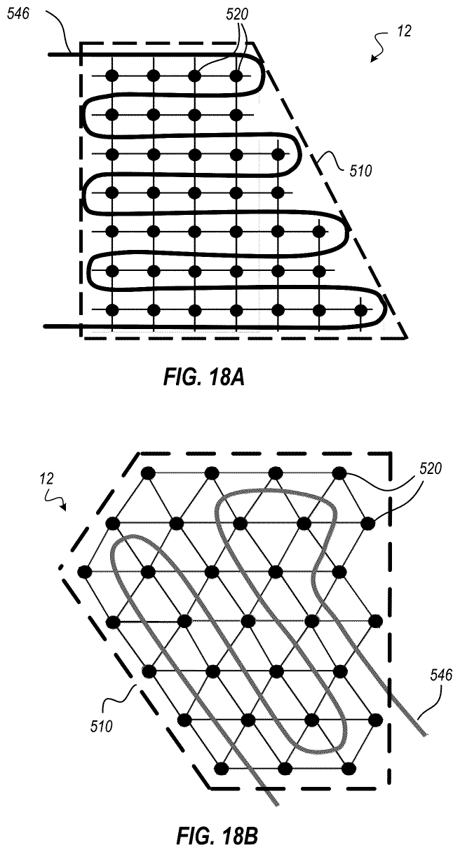

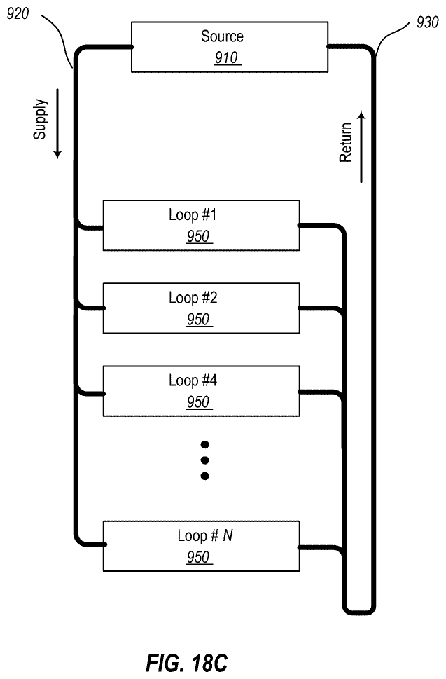

FIGS. 18A and 18B illustrate examples of a heat exchanger 12 having a non-rectangular shape. The heat exchanger 12 can have a structural base 510 on which posts 520 are arranged in a grid (e.g., a rectangular grid in FIG. 18A and a triangular grid in FIG. 18B). The structural base 510 can be cut into a desired shape (e.g., to fit around a pipe or fit within an irregularly shaped corner). Tubing 546 (e.g., cross-linked polyethylene pipe, such as PEX tubing) can be arranged along a path between the posts 520. The posts 520 can be shaped to hold the tubing 546 in place after it has been arranged among the posts 520. A thermal conductive material may be arranged to fill gaps remaining after the tubing 546 has been arranged among the posts 520. Then an aesthetic panel may be fixed over the structural base 510, the tubing 546, and the thermal-conductive, gap-filling material. The structural base 510 can include insulation 14 (e.g., polyfoam) that is attached to heat exchanger 12.

FIG. 18C illustrates an example of a reverse return piping configuration, which is used in accordance with certain embodiments. For example, a source 910 provides the thermal fluid via a supply pipe 910 from which each of the loops 950, which are numbered 1 through N, are fed. Each of the loops 950 is made up of series of modular thermal emitters 10 connected in series as illustrated in FIGS. 6A-6C or a modular thermal emitter configured by arranging the tubing 546 among the posts 520 as illustrated in FIGS. 14A-14B. Different number loops 950 can have different configurations and different types of modular thermal emitters 10. Preferably the loops 950 are matched to have a same flow rate, a same pressure drop and a same thermal load to provide efficient heat transfer. The return pipe 930 receives the output from each loop in a same order in which the supply was provided, as illustrated in FIG. 15C. In one example embodiment, loop #1 may include one or more modular thermal emitters 10 having irregular shape as illustrated in FIGS. 14A and 14B. Further, loops #2-N may include one or more modular thermal emitters 10 having rectangular shapes as illustrated in FIGS. 6B and 6C.

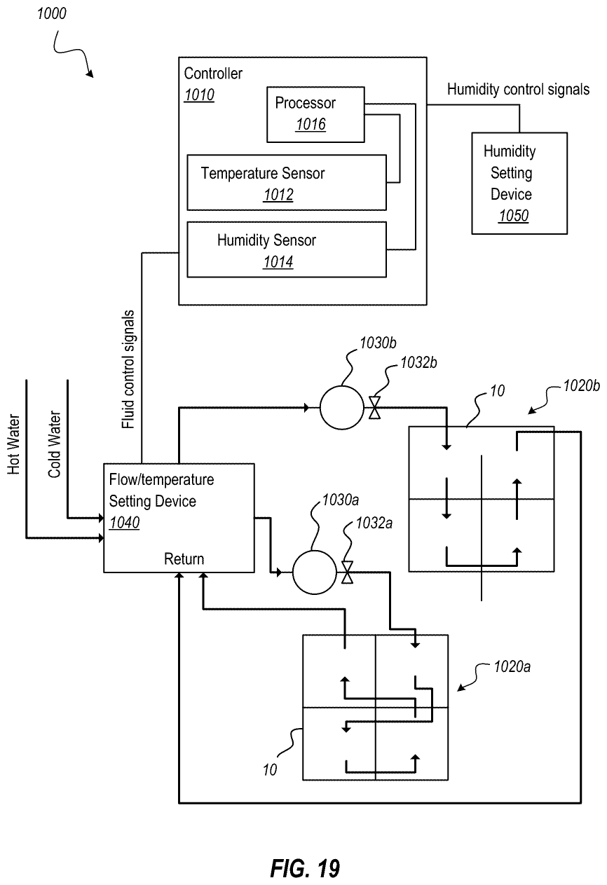

FIG. 19 illustrates a schematic diagram of a heating/cooling system 1000, which includes a controller 1010 and a device 1040. The controller 1010 uses a temperature sensor 1012 to measure the temperature of a room and a humidity sensor to measure the humidity of a room. A processor 1016 uses these measurements to determine humidity control signals and fluid control signals. For example, the processor 1016 may include a memory that stores settings for a desired humidity and a desired temperature. The humidity control signals are sent to a humidity setting device 1050. The fluid control signals are sent to a device 1040 that sets the flow and/or temperature of the thermal fluid through one or more groups 1020a and 1020b of the modular thermal emitters 10.

For example, a first group 1020a of modular thermal emitters 10 may be in a first zone, and a second group 1020b of modular thermal emitters 10 may be in a second zone. In the embodiment shown in FIG. 19, a first in-line pump 1030a provides fluid pressure causing the thermal fluid to flow through the first group 1020a and a valve 1032a is provided to restrict the flow. Similarly, a second in-line pump 1030b provides fluid pressure causing the thermal fluid to flow through the second group 1020b and a valve 1032b is provided to restrict the flow. Control signals from the device 1040 may control the in-line pumps 1030a and 1030b and the valves 1032a and 1032b. In alternative embodiments, the in-line pumps and valves can be integrated in the device 1040, and the number and arrangement of pumps and valves may differ.

Based on the fluid control signals, the device 1040 sets the temperature and/or flow of the thermal fluid to the respective groups 1020a and 1020b. This control may be binary, in which case the flow of the thermal fluid is either on or off and the temperature is either hot or cold (e.g., the thermal fluid source is the hot water or is the cold water). The thermal fluid may be water that is conveyed directly from the hot-water source and the cold-water source, which are input to the device 1040.

Alternatively, the thermal fluid may be on a closed circuit, and a heat exchanger in the device 1040 heats or cools the thermal fluid using the hot-water source and the cold-water source input to the device 1040. Further, the thermal fluid temperature may be controlled to continuously vary from a temperature of the hot-water source to a temperature of the cold-water source. Any known method may be used to obtain a desired temperature for the thermal fluid. Further, any known method may be used to obtain a desired flow rate for the thermal fluid.

For example, the groups 1020a and 1020b may be in a same zone, and the thermal fluid only flows through one of the two groups 1020a and 1020b when a low level of heating/cooling is desired. When more heating/cooling is desired, thermal fluid flows through both groups 1020a and 1020b. Further, a faster flow rate may be used when more heating/cooling is desired. This increase in heating/cooling with the flow rate is achieved because the temperature gradient from the input to output of a group of modular thermal emitters 10 will be less when a faster flow rate is used. Further, within a given group of modular thermal emitters 10 a series of valves might be arranged to bypass a subset of the modular thermal emitters 10 when less heating/cooling is desired.

After the thermal fluid passes through a group of modular thermal emitters 10 the thermal fluid returns to the devices 1040. The returned thermal fluid may then be wholly or partially reused by recirculating the thermal fluid. For example, the returned thermal fluid may be heated or chilled and again output to the group of modular thermal emitters 10. Alternatively, when the thermal fluid is water, a part of the returned water may be mixed with either the water from the hot-water source or the cold-water source to provide water of an intermediate temperature between the temperature of the hot-water source and the temperature of the cold-water source.

FIG. 19 illustrates that some groups of modular thermal emitters 10 (e.g., group 1020a) may be configured to optimize uniformity of heating/cooling, as discussed with reference to FIG. 6C. Other groups of modular thermal emitters 10 (e.g., group 1020b) may be configured with the thermal fluid flowing to a next nearest neighbor, reducing the length of tubing 46 between modular thermal emitters 10, as discussed with reference to FIG. 6B.

FIG. 20 illustrates a flow diagram of a method 1100 for heating and/or cooling using the modular thermal emitters 10. In step 1110 of method 1100, the modular thermal emitters 10 are arranged along an interior surface (e.g., wall or ceiling) in a residential, industrial, or commercial building. The modular thermal emitters 10 are arranged to substantially span the interior surface. The modular thermal emitters 10 substantially span the interior surface when the modular thermal emitters 10 have an area that is 15% or more of the area of the interior surface. For example, the modular thermal emitters 10 may span 20%, 30%, 40%, 50%, 60%, 70%, 80%, 90%, or 100% of the interior surface. The interior surface may be one wall or all the walls within a room. The interior surface may be one surface of a ceiling of a room or an entire surface of a ceiling of the room.

As discussed above, the advantage of substantially spanning the interior surface is that a determined amount of heat transfer is obtained with a smaller temperature differential between the modular thermal emitters 10 and the interior volume of the building being heated/cooled. For cooling, a smaller temperature differential is helpful because the humidity does not need to be lowered as much to maintain a dew point temperature below the temperature of the modular thermal emitters 10.

In step 1120 of method 1100, the modular thermal emitters 10 are distributed to have a higher density in certain areas of the interior volume of the building. For example, some rooms may have many machines (e.g., computers or servers) that consume large amounts of power and generate a large quantity of heat. A greater density of modular thermal emitters 10 may be used in these rooms to achieve a greater amount of heat transfer capable of dealing with the larger thermal load.

In step 1130 of method 1100, the modular thermal emitters 10 are connected using tubing 46, for example. The modular thermal emitters 10 may be connected with a next nearest neighbor or they may be connected to achieve a desired flow pattern through the respective modular thermal emitters 10, such as to achieve a desired heat transfer distribution (e.g., more uniform heat transfer).

In step 1140 of method 1100, the thermal fluid flows through the modular thermal emitters 10, and control of the temperature and/or flow of the thermal fluid through the modular thermal emitters 10 is used to achieve a desired amount of heat transfer. The desired amount of heat transfer may be determined using control logic (e.g., PID (proportional, integral, and derivative) control logic) to determine the amount of heat transfer required to maintain a given temperature, which may change as the thermal load in the room changes.

In step 1150 of method 1100, when the modular thermal emitters 10 are used for cooling, control of the humidity of the air in the interior volume of the building is used to maintain the dew point temperature below the temperature of the modular thermal emitters 10.

The order of these steps in method 1100 may be changed, and some steps of method 1100 may be performed simultaneously and/or omitted. For example, steps 1140 and 1150 may be performed simultaneously to control the flow and/or temperature of the thermal fluid while also controlling humidity of the air in the building.

FIG. 21 is a perspective view of a thermal paver system 1200 that includes modular thermal emitters similar to those described herein for use in ceilings and walls. The thermal paver system 1200 includes pavers 1202 that are generally flat pieces of material such as concrete, stone, ceramic, composite, or any other suitable material that can function well as flooring for indoor or outdoor use. The pavers 1202 shown herein are rectangular, but it is to be appreciated that other shapes are possible within the scope of this disclosure. The thermal paver system 1202 includes modular thermal units 1204 that are located under the thermal pavers 1202 and are interconnected and operated in a similar manner to other embodiments shown and described herein for use in a ceiling or a wall. Some or all of the quadrants in the paver system 1200 are active thermal units; some are passive. The refraction indices of the pavers 1202 can be chosen to promote heat transfer as desired and can be optimized for heating or for cooling.

The thermal paver system 1200 includes feet 1206 that support the modular thermal units 1204 and the pavers 1202. The feet 1206 can be located at the corners wherein the pavers 1202 meet. Some of the feet 1206 are rounded, and some may be trimmed to fit within a given space and so as to avoid interfering with other objects nearby such as a wall or stairs, etc. The feet 1206 may also include a disk 1208 that engages the pavers 1202 to prevent the pavers 1202 from being lifted up away from the feet 1206 such as by wind. In some embodiments the disks 1208 are the only thing preventing the pavers 1202 from being lifted up, and the pavers 1202 are otherwise unsecured to any other object in the system 1200. There is a rail 1210 at an edge of one paver 1202 that can provide a barrier between the thermal paver system 1200 and surrounding areas.

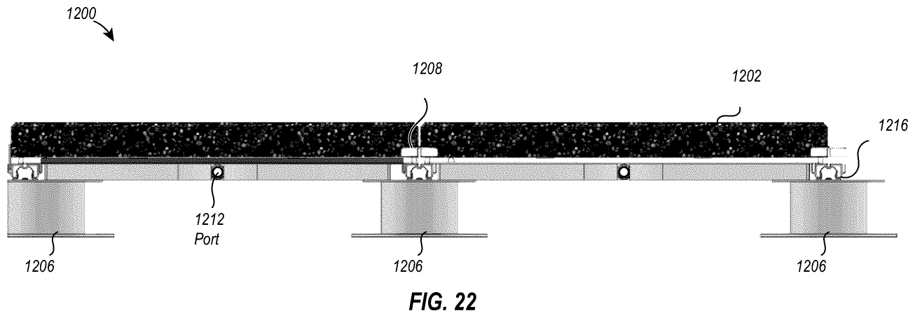

FIG. 22 is a side, cross-sectional view of the thermal paver system 1200. The pavers 1202 are shown at the top, with the disks 1208 at the corners, preventing the pavers 1202 from being lifted out of place. The modular thermal units 1204 are below the pavers 1202 and are in thermal contact with the pavers 1202 such that thermal energy can pass through the pavers 1202 to allow the modular thermal units 1204 to operate optimally. The disks 1208 are shown at the corners, along with supporting feet 1206. The thermal paver system 1200 can have any number of pavers 1202 and modular thermal units 1204 according to the size and heat transfer needs of a given installation. The thermal pavers system 1200 is therefore entirely configurable and customizable.

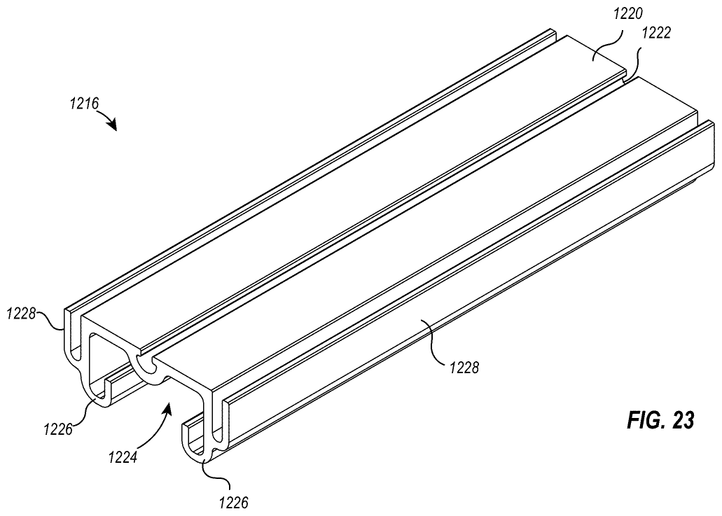

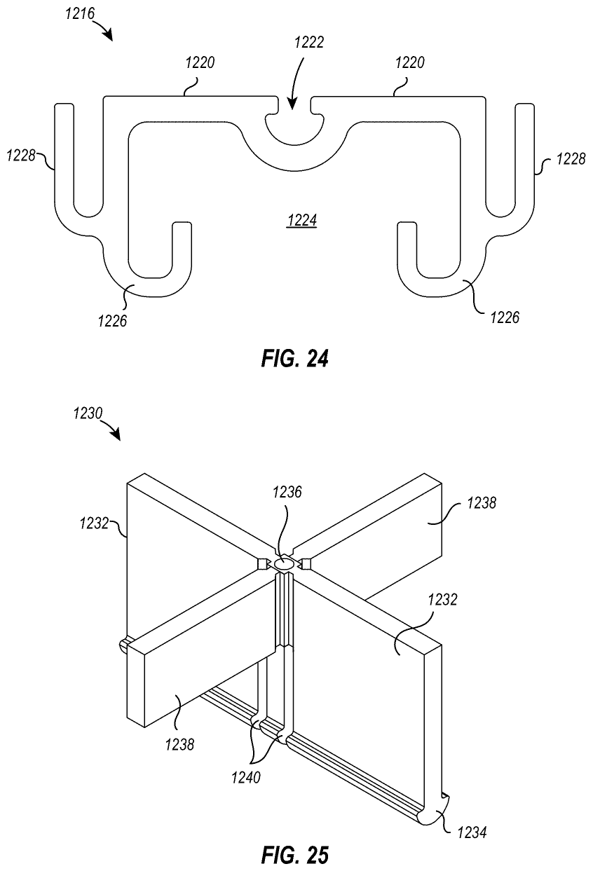

FIG. 23 is a Paver Trak™ 1216 for use with a thermal paver system. The Paver Trak 1216 is an elongated member with a generally uniform cross-sectional shape. FIG. 24 is an end view of the Paver Trak 1216 which is described herein together with FIG. 23. The Paver Trak 1216 has a top surface 1220 that is generally flat and supports the modular thermal unit that will rest atop the Paver Trak 1216. At a center of the top surface 1220 is an upper rail recess 1222 that extends along the Paver Trak 1216 and can receive components in a way that permits the components to move along the Paver Trak 1216 and prevents the components from being lifted out of the upper rail recess 1222. Beneath the top surface 1220 is a tunnel 1224 flanked by two J-rails 1226 that each have downward and inward projections that define the tunnel 1224. At an outward side of each J-rail are two U-rails 1228 that extend outwardly and upwardly from the J-rails 1226. The U-rails 1228 extend upward nearly as high as the top surface 1220. The Paver Trak 1216 is used to define an interface between two modular thermal units and their corresponding pavers as will be shown and described in greater detail below.

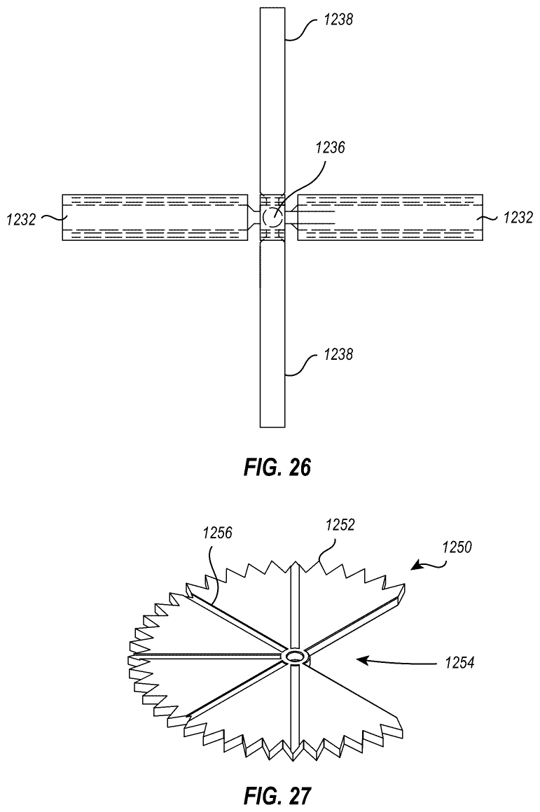

FIG. 25 is a perspective view of a corner spacer 1230 for use with the Paver Trak 1216 in the thermal paver system of the present disclosure. FIG. 26 is a top view of the corner spacer 1230 according to embodiments of the present disclosure. The corner spacer 1230 is a cross-shaped member with generally flat, vertically oriented members that provides spacing and support for the modular thermal units and pavers of the thermal paver system. The shown embodiments feature right angles between the pavers; however, it is to be understood that other angles are possible. The corner spacer 1230 includes a spacer tab 1232 having a generally uniform thickness with a head rail 1234 at a bottom end. The head rail 1234 fits within the upper rail recess 1222 in the Paver Trak 1216 shown in FIGS. 23 and 24. The corner spacer 1230 can be inserted into the upper rail recess 1222 and slid to a desired location.

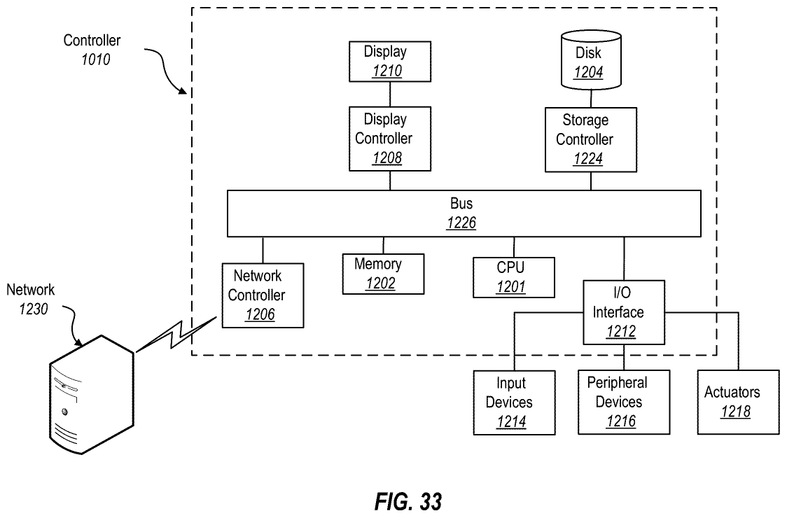

At the center of the corner spacer 1230 is a nexus 1236 that has a vertical hole therethrough. There is a half tab 1238 extending from the nexus 1236 and perpendicularly relative to the spacer tabs 1232. The upper portions of the half tabs 1238 and the spacer tabs 1232 are flush, but the half tabs 1238 do not extend all the way to the hear rail 1234. The dimensions and relative dimensions of these components can vary. In some embodiments the spacer tabs 1232 are high enough to interfere with the paver and the modular thermal unit, whereas the half tabs 1238 contact the paver and do not extend below the paver. FIG. 33 shows the interface between the corner spacer 1230, the paver 1202, and the modular thermal unit 1204 to greater advantage.

FIG. 27 is a perspective view of a disk 1250 according to embodiments of the present disclosure. The disk 1250 is a generally thin, flat, circular member having a notched profile 1252 to facilitate manual rotation of the disk 1250 such as with a thumb or a tool. The disk includes alignment marks that can be integrally formed, printed, or embossed onto the disk 1250 and provide an indication of dimensions that are helpful for using the disk 1250. In the shown embodiments the pavers are square and the angles between them are approximately 90 degrees. It is to be appreciated that other dimensions are possible and with slight adjustments to the angles and construction of these components other configurations are possible. For example, a hexagonal paver system can be envisioned in which the angles are 60.

The disk 1250 has a ¼ recess 1254 that allows the disk 1250 to be rotated to a desired angular position to remove a paver through the ¼ recess 1254. The disk 1250 also includes a pin 1258 that passes through the center of the disk 1250 and into the nexus 1236 of a corner spacer 1230 shown in FIGS. 25 and 26. The pin 1258 allows rotation of the disk 1250 to selectively prevent or allow the pavers to be lifted out of the system such as to replace or repair a paver, or for access to components below the pavers.

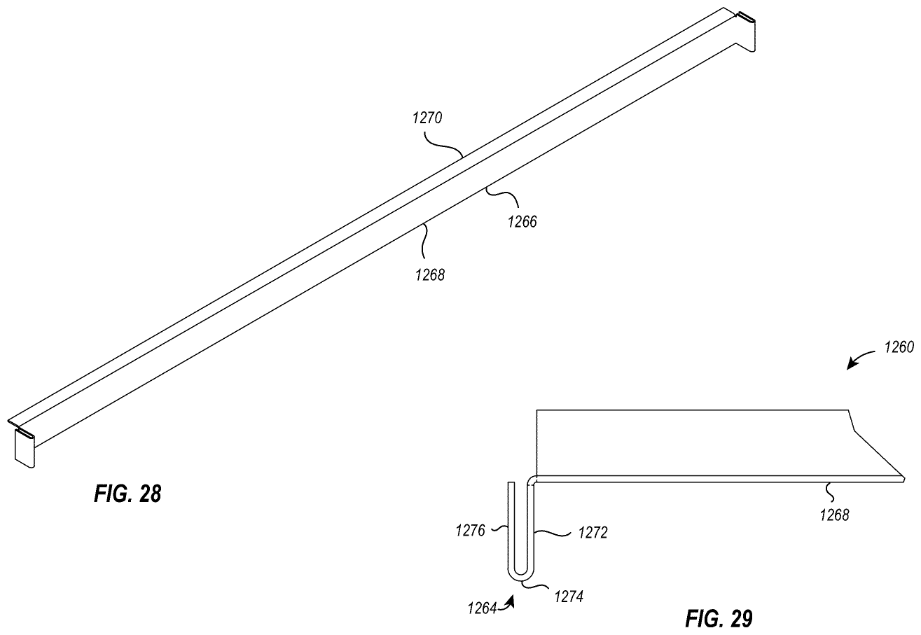

FIG. 28 shows an edge restraint 1260 for use with the thermal paver system of the present disclosure. The edge restraint 1260 is an elongated member having an L-shaped profile having a vertical portion 1268 and a horizontal portion 1270. At each end of the edge restraint is a tab 1264 that interfaces with paves to provide support and a barrier between pavers and a surrounding environment.

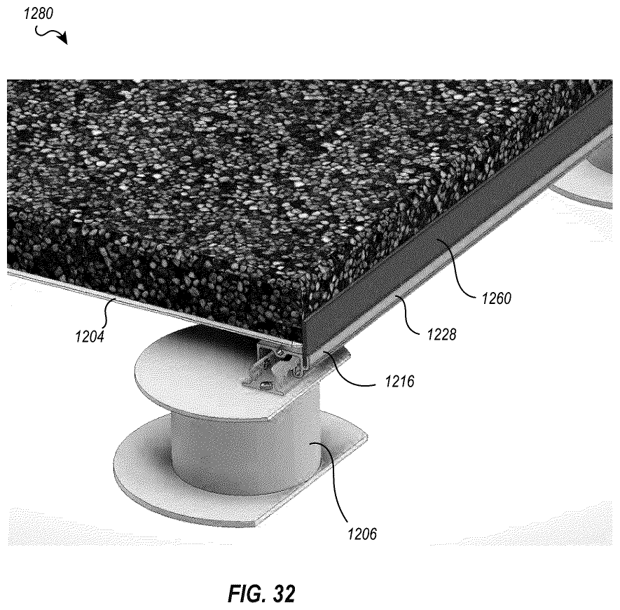

FIG. 29 is a partial view of an end of an edge restraint 1260 for use with the thermal paver system. The edge restraint 1260 is rotated to show features of the tab 1264. The vertical portion 1268 is shown edgewise, and the horizontal portion 1270 is shown broadly. The tab 1264 includes a first tab portion 1272 extending downwardly from the vertical portion 1268, a U portion 1274, and a second tab portion 1276. The L-shaped profile receives a paver, and the tabs 1264 can fit between pavers in a manner that is shown to greater advantage in FIG. 32.

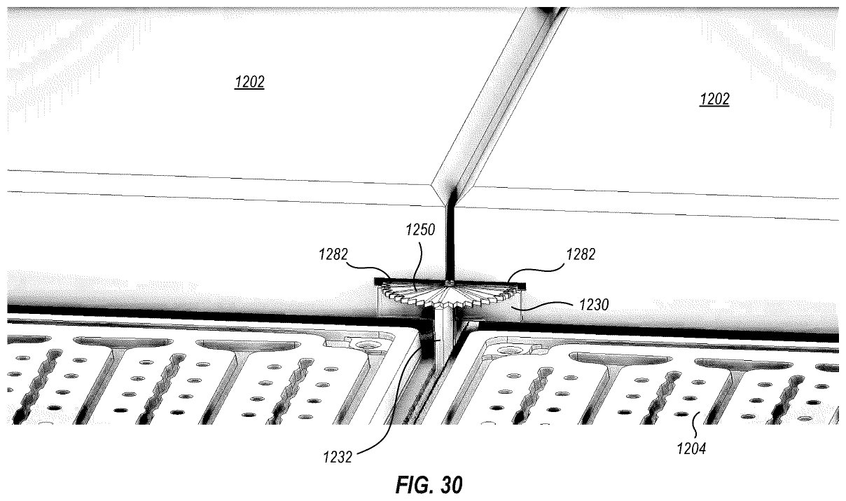

FIG. 30 is a perspective view of a lift restraint assembly 1280 as part of the thermal paver system. Two pavers 1202 are shown with two pavers removed. The pavers 1202 have a horizontal slot 1282 formed therein that is sized and positioned to receive the disk 1250. The disk 1250 is secured to the corner spacer 1230 below but can rotate. As shown, the ¼ recess of the disk is within the pavers 1202 and in this position the disk 1250 prevents all four of the pavers from being lifted (if there were pavers in the two vacant positions). Rotating the disk 1250 can be done by a screwdriver or other appropriate tool at the junction of the pavers allows the pavers 1202 to be removed one at a time. The corner spacer 1230 is shown with the spacer tab 1232 embedded within the upper rail recess 1222 of the Paver Trak 1216. The half tabs 1238 are tall enough to extend from the slot 1282 to the bottom of the pavers 1202, but do not extend downward and as such the modular thermal units 1204 can be moved below the pavers and the half tabs 1238 if so desired.

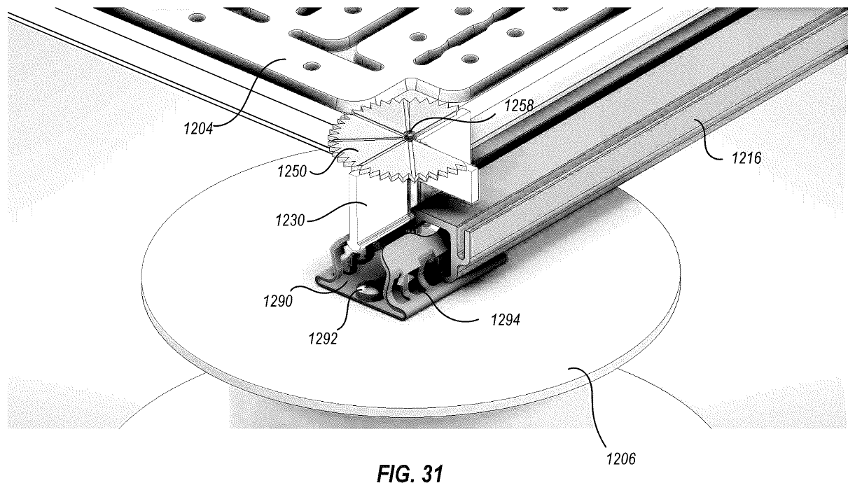

FIG. 31 is a perspective view of a corner assembly 1280 for a modular thermal unit, a foot, and a lift resistant assembly. The assembly 1280 includes a foot 1206, and a paver trak clip 1290 that is fastened to the foot 1206 by a screw 1292. The paver trak clip 1290 is an elongated member having a generally uniform cross-section including a flat base that contacts the foot 1206 and supports the assembly. The paver trak clip 1290 also includes guides 1294 that project upward from the flat base and extend parallel with the paver trak 1216. The guides 1294 include features that complement the J-rails of the paver trak 1216 and provide a support for the paver trak 1216.

FIG. 32 is a perspective view of a lift restraint assembly 1280 according to embodiments of the present disclosure. The assembly 1280 includes an edge restraint 1260 that comprises an elongated flat member that fits within U-rails 1228 and projects upward and provides a barrier that prevents the paver 1204 from moving or sliding around.

FIG. 33 illustrates a schematic diagram of a controller 1310 for heating and/or cooling using the modular thermal emitters 10. A hardware description of an exemplary controller 1310 used in accordance with some embodiments described herein is given with reference to FIG. 33.

In FIG. 33, the controller 1310 includes a CPU 1301 which performs the heating/cooling control processes and methods described above and herein after. The process data and instructions can be stored in memory 1302. These processes and instructions can also be stored on a storage medium disk 1304 such as a hard drive (HDD) or portable storage medium, or can be stored remotely. Further, the claimed features are not limited by the form of the computer-readable media on which the instructions of the process are stored. For example, the instructions can be stored on CDs, DVDs, in FLASH memory, RAM, ROM, PROM, EPROM, EEPROM hard disk or any other information processing device with which the controller 1310 communicates, such as a server or computer.

Further, the claimed features can be provided as a utility application, background daemon, or component of an operating system, or combination thereof, executing in conjunction with CPU 1301 and an operating system such as Microsoft Windows, UNIX, Solaris, LIMA, Apple MAC-OS and other systems known to those skilled in the art. Additionally or alternatively, the CPU 1301 may be a microcontroller (e.g., the and the CPU 1301 may be one of an ARM Cortex-M3, a Cortex-M4F, an ARM7TDMI, an Atmel AVR, or an eSi-RISC processor) and the operating system Micro-Controller Operating Systems (MicroC/OS or μC/OS), a real-time operating system, or a proprietary operating system, for example.

The hardware elements to achieve the controller 1310 can be realized by various circuitry elements, known to those skilled in the art. For example, CPU 1301 can be a Xenon or Core processor from Intel of America or an Opteron processor from AMD of America. Additionally, or alternatively, the CPU 1301 can be an ARM architecture CPU such as the Cortex A53 by ARM Inc., a Snapdragon 810 by Qualcomm, Inc., or an Intel Atom CPU by Intel Corporation, or can be other processor types that would be recognized by one of ordinary skill in the art. For example, the CPU 1301 can be microcontroller, such as an Intel 8051 microcontroller, an ATMEL AT89C51 microcontroller, a peripheral interface controller microcontroller unit (PIC MCU), or other microcontroller. Alternatively, the CPU 1301 can be implemented on an field programmable gate array (FPGA), application specific integrated circuit (ASIC), programmable logic device (PLD) or using discrete logic circuits, as one of ordinary skill in the art would recognize. Further, CPU 1301 can be implemented as multiple processors cooperatively working in parallel to perform the instructions of the inventive processes described above and below.

The controller 1310 in FIG. 33 also includes a network controller 1306 for interfacing with network 1330. As can be appreciated, the network 1330 can be a public network, such as the Internet, or a private network such as an LAN or WAN network, or any combination thereof and can also include PSTN or ISDN sub-networks. The network 1330 can also be wired, such as an Ethernet network, or can be wireless such as a cellular network including EDGE, 3G and 4G wireless cellular systems. The wireless network can also be WiFi Bluetooth, nearfield communication or any other wireless form of communication that is known.

The controller 1310 further includes a display controller 1308 for interfacing with display 1311, such as a touch screen LCD display. A general purpose I/O interface 1312 interfaces with input devices 1314, such as a keypad that can be used to enter desired temperature settings or whether the heating/cooling system is set to heat or to cool the room. The general purpose I/O interface 1312 interfaces with peripheral devices 1316, such as a touch screen panel, a remote control, an Amazon Alexa device, or smart devices like a smart phone or a smart watch that can be used to remotely set the desired temperature. For example, the controller 1310 may be integrated into an internet of things. General purpose I/O interface 1312 also connects to a variety of actuators 1318 including valves, pumps, or solid-state relay devices to control the thermal fluid flow, heat transfer to the thermal fluid flow, or other actuators used in the heating/cooling system. The actuators 1318 can also include light, sound or haptic devices, such as a light (e.g., an LED) or a speaker used to communicate warnings or other signals.

The general-purpose storage controller 1324 connects the storage medium disk 1304 with communication bus 1326, which can be an ISA, EISA, VESA, PCI, or similar, for interconnecting all the components of the controller 1310.

The invention can be described in a number of different configurations. In one configuration the invention includes a radiative heating and/or cooling system, comprising: modular thermal emitters fixed within a building and being arranged to span a substantial part of an interior surface of the building, wherein: each of the modular thermal emitters comprising a planar member having channels disposed therein conveying a thermal fluid from an inlet of one of the modular thermal emitters to an outlet of the one of the modular thermal emitters, and the plurality of modular thermal emitters comprises a fluid conduit configured to convey the thermal fluid from the outlet of the one of the modular thermal emitters to an inlet of another of the modular thermal emitters; and a controller configured to control a flow of the thermal fluid through the modular thermal emitters.

In additional or alternative configurations, the invention includes a humidity regulator that measures a humidity of the building and modifies the humidity to maintain a dew point temperature below a temperature of the plurality of modular thermal emitters.

In additional or alternative configurations, the interior surface is a wall and/or a ceiling of an enclosed space of the building, and the building is a residential building, a commercial building, or an industrial building.

In additional or alternative configurations, the invention one of the modular thermal emitters in fluid communication with the another of the modular thermal emitters via the fluid conduit without any mechanical connectors along a pathway of the thermal fluid from the one of the modular thermal emitters to the another of the modular thermal emitters.

In additional or alternative configurations, the modular thermal emitters are reconfigurable without disassembling the interior surface of the building.

In additional or alternative configurations, the modular thermal emitters are fixed to the interior surface of the building using a channel support structure that is fixed to the interior surface, and channels in the channel support structure hold the modular thermal emitters along a periphery of the modular thermal emitters.

In additional or alternative configurations, the channel support structure comprises anti-uplift structures that prevent movement of the modular thermal emitters in response to a change in room pressure.

In additional or alternative configurations, the modular thermal emitters are fixed to the interior surface of the building using one of: one or more fasteners secured to the interior surface of the building through one or more preformed attachment points within the respective modular thermal emitters, attachments to a support lattice for a suspended ceiling, one or more fasteners securing the modular thermal emitters to framing members, rafters, ceiling beams, or ceiling trusses, a channel supporting a perimeter of the modular thermal emitters, fasteners fixing the channel either to one or more sheets of dry wall, one or more CMU, or structural wall or ceiling, or suspending the modular thermal emitters from a structural ceiling using suspension wire or using a suspension fastener.

In additional or alternative configurations, when the thermal fluid fills the channels of a respective modular thermal panel of the of modular thermal emitters, a ratio of a thermal mass of the thermal fluid to a thermal mass of the respective modular thermal panel is greater than 0.5.

In additional or alternative configurations, the modular thermal emitters are fixed to the interior surface in a manner that reduces a plenum space relative to a forced air heating and/or cooling system.

In additional or alternative configurations, a temperature of the thermal fluid changes in a direction towards a room temperature as the thermal fluid flows through the respective modular thermal emitters, and an order of the thermal fluid flow through the respective modular thermal emitters is set to more uniformly heat and/or cool the building relative to an order of the thermal fluid flow in which the thermal fluid flow is conveyed from a current modular thermal panel to a next closest modular thermal panel.

In additional or alternative configurations, the modular thermal emitters are preassembled into groups of two or more modular thermal emitters thereby improving case of installation.

In additional or alternative configurations, the groups of two or more modular thermal emitters are configured to be installed by sliding the groups of two or more modular thermal emitters into respective channels attached to the interior surface of the building.

In additional or alternative configurations, the invention includes a thermal insulator in thermal communication with a first face of the planar member, the first face facing towards a plenum space.

In additional or alternative configurations, the invention includes a thermal conductor in thermal communication with a second face of the planar member, the second face facing away from the plenum space and towards am interior of the building, the thermal conductor being one of a ceiling tile, an acoustic tile, a decorative tile, a wall panel, a plaster, or one or more sheets of drywall.

In additional or alternative configurations, the channels are non-circular and are molded between two sheets that form the planar member.

In additional or alternative configurations, an input channel conveys the thermal fluid from an inlet, the input channel fans out and bifurcates into branches spanning a substantial part of the planar member, and the branches combine to form an output channel conveying the fluid to an outlet.

In additional or alternative configurations, the channels are shaped to turbulate a flow of the thermal fluid and to provide a more even heat distribution throughout the channels.

In additional or alternative configurations, the channels are shaped to include off-center obstructions that turbulate the flow of the thermal fluid.

In additional or alternative configurations, the building is zoned to have a greater density of the modular thermal emitters in zones requiring more heat transfer.

In additional or alternative configurations, the modular thermal emitters are attached to a suspended ceiling using an attachment structure configured to attach to a horizontal portion of a support lattice of the suspended ceiling, wherein a lower portion of the support lattice has a cross-section shaped as an inverted T-shape and the horizontal portion of the support lattice corresponds to a bottom of the inverted T-shape, and the attachment structure includes a hook that extends around one end of the horizontal portion of the support lattice and includes a foldable tab that folds over another end of the horizontal portion of the support lattice.

In additional or alternative configurations, the invention includes a method of heat transfer using modular thermal emitters, the method comprising: arranging modular thermal emitters within a building to span a substantial part of an interior surface of the building; circulating a thermal fluid through channels in respective planar members of the modular thermal emitters, wherein: each of the modular thermal emitters comprises a planar member having channels disposed therein conveying a thermal fluid from an inlet of one of the modular thermal emitters to an outlet of the one of the modular thermal emitters, and the plurality of modular thermal emitters comprises a fluid conduit configured to convey the thermal fluid from the outlet of the one of the modular thermal emitters to an inlet of another of the modular thermal emitters; and controlling, using a controller, a flow of the thermal fluid through the modular thermal emitters.

In additional or alternative configurations, the invention includes regulating a humidity using a humidity regulator that measures a humidity of the building and modifies the humidity to maintain a dew point temperature below a temperature of the plurality of modular thermal emitters.

In additional or alternative configurations, arranging the modular thermal emitters further includes arranging the modular thermal emitters to span a substantial part of the interior surface of the building, wherein the interior surface is a wall and/or a ceiling of an enclosed space of the building, and the building is a residential building, a commercial building, or an industrial building.

In additional or alternative configurations, the invention includes connecting the modular thermal emitters together via the fluid conduit such that the one of the modular thermal emitters in fluid communication with the another of the modular thermal emitters via the fluid conduit without any mechanical connectors along a pathway of the thermal fluid from the one of the modular thermal emitters to the another of the modular thermal emitters.

In additional or alternative configurations, the invention includes reconfiguring the fluid conduit to change an order in which the thermal fluid flows through the modular thermal emitters, wherein the reconfiguring the fluid conduit is performed without disassembling the interior surface of the building.

In additional or alternative configurations, arranging the modular thermal emitters further includes that the modular thermal emitters are fixed to the interior surface of the building using a channel support structure that is fixed to the interior surface, and channels in the channel support structure hold the modular thermal emitters along a periphery of the modular thermal emitters.

In additional or alternative configurations, the channel support structure comprises anti-uplift structures that prevent movement of the modular thermal emitters in response to a change in room pressure.

In additional or alternative configurations, arranging the modular thermal emitters further includes that the modular thermal emitters are fixed to the interior surface of the building using one of: one or more fasteners secured to the interior surface of the building through one or more preformed attachment points within the respective modular thermal emitters, attachments to a support lattice for a suspended ceiling, one or more fasteners securing the modular thermal emitters to framing members, rafters, ceiling beams, or ceiling trusses, a channel supporting a perimeter of the modular thermal emitters, fasteners fixing the channel either to one or more sheets of dry wall, one or more concrete masonry units, or a structural wall or ceiling, or suspending the modular thermal emitters from a structural ceiling using suspension wire or using a suspension fastener.

In additional or alternative configurations, circulating the thermal fluid through channels further includes that a thermal mass of the thermal fluid filling the channels of a respective modular thermal panel of the of modular thermal emitters is greater than 0.5 times a thermal mass of the respective modular thermal panel.

In additional or alternative configurations, arranging the modular thermal emitters within the building further includes that the modular thermal emitters are fixed to the interior surface in a manner that reduces a plenum space relative to a method that uses forced air heating and/or cooling through ductwork.

In additional or alternative configurations, circulating the thermal fluid further includes that a temperature of the thermal fluid changes in a direction towards a room temperature as the thermal fluid flows through the respective modular thermal emitters, and an order in which the thermal fluid flows through the respective modular thermal emitters is set to more uniformly heat and/or cool the building relative to an order of the thermal fluid flow in which the thermal fluid flow is conveyed from a current modular thermal emitter to a next closest modular thermal emitter.

In additional or alternative configurations, the invention includes preassembling the modular thermal emitters into groups of two or more modular thermal emitters and installing the groups of two or more modular thermal emitters as a single unit to improve case of installation.

In additional or alternative configurations, the invention includes installing the groups of two or more modular thermal emitters by sliding the groups of two or more modular thermal emitters into respective channels attached to the interior surface of the building.

In additional or alternative configurations, each of the modular thermal emitters comprises a thermal insulator in thermal communication with a first face of the planar member, the first face facing towards a plenum space or mounting surface.

In additional or alternative configurations, each of the modular thermal emitters comprises: a thermal conductor in thermal communication with a second face of the planar member, and the second face facing away from the plenum space and towards an interior of the building, the thermal conductor being one of a ceiling tile, an acoustic tile, a decorative tile, a wall panel, a plaster, and one or more sheets of drywall.

In additional or alternative configurations, the channels are non-circular and are molded between two sheets that form the planar member.

In additional or alternative configurations, the invention includes conveying the thermal fluid through an inlet to an input channel, which fans out and bifurcates into branches spanning a substantial part of the planar member and the branches then recombine to form an output channel, wherein the thermal fluid is conveyed through the branches and into the output channel where the thermal fluid exits through an outlet of the planar member.

In additional or alternative configurations, the invention includes turbulating the thermal fluid by the channels being shaped to turbulate a flow of the thermal fluid and to provide a more even heat distribution throughout the channels.

In additional or alternative configurations, turbulating the thermal fluid further includes that the channels are shaped to include off-center obstructions that turbulate the flow of the thermal fluid.

In additional or alternative configurations, the invention includes zoning the building by arranging the modular thermal emitters to have a greater density of the modular thermal emitters in zones requiring more heat transfer.

In additional or alternative configurations, the invention includes attaching the modular thermal emitters to a suspended ceiling using an attachment structure that attaches to a horizontal portion of a support lattice of the suspended ceiling, wherein: a lower portion of the support lattice has a cross-section shaped as an inverted T-shape and the horizontal portion of the support lattice corresponds to a bottom of the inverted T-shape, and the attachment structure includes a hook that extends around one end of the horizontal portion of the support lattice and includes a foldable tab that folds over another end of the horizontal portion of the support lattice.

In additional or alternative configurations, the invention includes a modular thermal panel including a planar member comprising a thermal conductor having enclosed channels disposed therein, the enclosed channels being configured to provide flow of a fluid from an input channel to an output channel, and the enclosed channels fanning out from the input channel into a plurality of branches and then recombining to form the output channel; an inlet port in fluid communication with the input channel and configured to feed the fluid into the heat exchanger; and an outlet port in fluid communication with the input channel and configured to receive the fluid exiting the heat exchanger.

In additional or alternative configurations, the enclosed channels occupy 35% or more of an area of the modular thermal emitter.

In additional or alternative configurations, the modular thermal emitters are formed by two sheets at least one of the sheets comprising the thermal conductor, and the sheets including ridges, and when the sheets are affixed to each other the ridges form the enclosed channels.

In additional or alternative configurations, the enclosed channels are shaped with obstructions.

In additional or alternative configurations, the obstructions are configured to disrupt laminar flow and induce turbulence that provides a more uniform temperature distribution throughout the enclosed channels.

In additional or alternative configurations, for a respective channel of the plurality of branches, the obstructions are arranged off center of the respective channel and are arranged to allow the fluid flows around all sides of the obstructions.

In additional or alternative configurations, the invention includes a sound absorber in thermal communication with the planar member and arranged to cover one side of the planar member, the sound absorber having a thermal conductivity greater than 0.1 watts per meter per degree centigrade, and the sound absorber having a same appearance as a ceiling tile.

In additional or alternative configurations, the sound absorber is configured as a heat spreader that diffuses heat across a face of the planar member and increases a uniformity of a temperature distribution across the modular thermal panel.

In additional or alternative configurations, the enclosed channels correspond to ridges in an outer contour of the modular thermal emitter, and the ridges increase an outer surface area of the modular thermal panel by 45% relative to an outer surface area the modular thermal emitter would have if the outer contour were flat without ridges.

In additional or alternative configurations, an albedo of a face of the modular thermal emitter is 50% or greater for a blackbody spectrum of 25 degrees centigrade.

In additional or alternative configurations, an emissivity of a face of the modular thermal emitter is 50% or greater at 25 degrees centigrade.

In additional or alternative configurations, the invention includes an inlet tube in fluid communication with the inlet port, and the inlet tube being configured to connect the modular thermal emitter to an outlet port of a second modular thermal panel, and an outlet tube in fluid communication with the outlet port, and the outlet tube being configured to connect the modular thermal emitter to an inlet port of a third modular thermal emitter.

In additional or alternative configurations, a combination of the input channel, the plurality of branches, and the output channel are sized and shaped to provide substantially equal flow rates through respective branches of the plurality of branches.

In additional or alternative configurations, the invention includes a support rail for supporting modular thermal emitters in a suspended ceiling, comprising: a first support member comprising an elongated member with a cross-section having an inverted T-shape comprising an upright portion and a horizontal portion, the horizontal portion being configured to support a modular thermal panel, the elongated member being configured to attach to a support lattice of a suspended ceiling and/or attach to a structural ceiling via a suspension wire; and a second support member configured perpendicular to the first support member, the second support member comprising an elongated member with a cross-section having an inverted T-shape comprising an upright portion and a horizontal portion, the horizontal portion being configured as a support the modular thermal panel, and second support member being configured to connect to the first support member, wherein the first support member and the second support member, when connected together, form a part of a support lattice that supports a plurality modular thermal emitters in a suspended ceiling.

In additional or alternative configurations, when the first support member is configured to attach to the support lattice of the suspended ceiling, an upper end of the upright portion of the first support member comprises an attachment structure configured to attach to the support lattice of the suspended ceiling.

In additional or alternative configurations, the attachment structure is configured to attach to a horizontal portion of the support lattice of the suspended ceiling, wherein a lower portion of the support lattice has a cross-section shaped as an inverted T-shape and the horizontal portion of the support lattice corresponds to a bottom of the inverted T-shape, and the attachment structure includes a hook that extends around one end of the horizontal portion of the support lattice and includes a foldable tab that folds over another end of the horizontal portion of the support lattice.

In additional or alternative configurations, when the first support member is configured to attach to the structural ceiling via suspension wires, the elongated member of the first support member comprises through holes through which the suspension wire passes to attach the suspension wire to the first support member.

In additional or alternative configurations, the first support member further comprises another horizontal portion fixed to the upright portion, the another horizontal portion being sized and spaced from the horizontal portion to support a ceiling tile.

In additional or alternative configurations, the invention includes a heat transfer system, comprising modular thermal emitters comprising a thermal conductor having enclosed channels disposed therein, the enclosed channels being configured to provide flow of a fluid from an input channel to an output channel, and the enclosed channels fanning out from the input channel into a plurality of branches and then recombining to form the output channel, and a support lattice comprising elongated support members having a cross-section with an inverted T-shape that includes an upright portion and a horizontal portion, the horizontal portion being configured to support the modular thermal emitters, and the support lattice being configured to be suspended from a structural ceiling either by connecting to an acoustic-tile support system or by connecting to suspension wires.

In additional or alternative configurations, the invention includes a controller that controls a temperature of a room in which the modular thermal emitters are arranged by controlling a flow of the fluid flowing through the enclosed channels and/or controlling a temperature of the fluid.

In additional or alternative configurations, the invention includes a humidity controller that controls a humidity of a room in which the modular thermal emitters, the humidity controller maintaining the humidity of the room below a dew point of a temperature of the modular thermal emitters.

In additional or alternative configurations, the invention includes a controller that controls respective zones to have different temperatures by controlling the fluid flowing through the enclosed channels of the modular thermal emitters such that, in accordance with the different temperatures that are set for the respective zones, the fluid in the respective zones have different flow rates and/or to have different temperatures depending on the different temperatures that are set for the respective zones.

In additional or alternative configurations, the invention includes ceiling tiles supported by the support lattice. In additional or alternative configurations, the ceiling tiles are integrated with the modular thermal. In additional or alternative configurations, the ceiling tiles are arranged above or below the modular thermal emitters.

In additional or alternative configurations, the support lattice forms a grid comprising tile sites that are shaped as a polygon or as a geometric shape with a curved edge, the modular thermal emitters are arranged at some but not all the tile sites, and a density of the modular thermal emitters corresponds to a percentage of the tile sites occupied by modular thermal emitters.

In additional or alternative configurations, the heat transfer system is arranged in zones, the zones being set to have different amounts of heat transfer, including a first zone set to have more heat transfer than a second zone, and the density of the modular thermal emitters being greater in the first zone than in the second zone.

In additional or alternative configurations, the invention includes a controller that controls temperatures in respective zones of a building by respectively controlling temperatures of the modular thermal emitters in the respective zones, the temperatures of the modular thermal emitters being controlled by controlling flow of the fluid and/or temperature of the fluid among the respective zones, wherein: the humidity controller controls the humidity to be below a dew point of a lowest temperature, among the respective zones, of the modular thermal emitters.

In additional or alternative configurations, the modular thermal emitters are configured to radiatively cool a space below the modular thermal emitters by a lower face of the modular thermal emitters having an albedo of 50% or greater for a black body spectrum of 25 degrees centigrade.

In additional or alternative configurations, the modular thermal emitters are configured to radiatively heat a space below the modular thermal emitters by a lower face of the modular thermal emitters having an emissivity of 50% or greater for at a temperature of 25 degrees centigrade.

In additional or alternative configurations, the modular thermal emitters span 50% or more of an area of a suspended ceiling.

In additional or alternative configurations, the density of the modular thermal emitters is selected to provide a predefined quantity of heat transfer without a temperature difference exceeding 10 degrees centigrade, 15 degrees centigrade, or 20 degrees centigrade; and the temperature difference being a difference between a temperature of the modular thermal emitters and a temperature of a space from which the heat is being transferred.

In additional or alternative configurations, the controller controls a temperature difference to not exceed 10 degrees centigrade, 15 degrees centigrade, or 20 degrees centigrade; and the temperature difference being a difference between a temperature of the modular thermal emitters and a temperature of the room.

In additional or alternative configurations, the modular thermal emitters comprise an insulator above the thermal conductor, the insulator configured to prevent heat transfer to a space above the modular thermal emitters.

In additional or alternative configurations, the invention includes a method of heat transfer, comprising: suspending a support lattice from a structural ceiling, the support lattice comprising elongated support members having a cross-section with an inverted T-shape that includes an upright portion and a horizontal portion, the horizontal portion being configured to support the modular thermal emitters, and the support lattice being configured to be suspended from a structural ceiling either by connecting to an acoustic tile support system or by connecting to suspension wires; arranging modular thermal emitters within the support lattice to be supported by the horizontal portion of the elongated support members, the modular thermal emitters comprising a thermal conductor having enclosed channels disposed therein, the enclosed channels being configured to provide flow of a fluid from an input channel to an output channel, and the enclosed channels fanning out from the input channel into a plurality of branches and then recombining to form the output channel; and controlling an amount of heat being transferred by controlling via a controller, a flow the fluid through the enclosed channels and/or a temperature of the fluid.

In additional or alternative configurations, the invention includes controlling a humidity of a space from which heat is being transferred to maintain the humidity below a dew point corresponding to a temperature of the modular thermal emitters.

In additional or alternative configurations, the modular thermal emitters are configured to radiatively cool a space below the modular thermal emitters by a lower face of the modular thermal emitters having an albedo of 25% or greater for a black body spectrum of 25 degrees centigrade.

In additional or alternative configurations, the modular thermal emitters are configured to radiatively heat a space below the modular thermal emitters by a lower face of the modular thermal emitters having an emissivity of 25% or greater for at a temperature of 25 degrees centigrade.

In additional or alternative configurations, the modular thermal emitters span 25% or more of an area of a suspended ceiling.

In additional or alternative configurations, the modular thermal emitters are configured to radiatively cool a space below the modular thermal emitters by a lower face of the modular thermal emitters having an albedo of 15% or greater for a black body spectrum of 25 degrees centigrade.

In additional or alternative configurations, the modular thermal emitters are configured to radiatively heat a space below the modular thermal emitters by a lower face of the modular thermal emitters having an emissivity of 15% or greater for at a temperature of 25 degrees centigrade.

In additional or alternative configurations, the modular thermal emitters span 15% or more of an area of a suspended ceiling.

In additional or alternative configurations, the enclosed channels occupy 25% or more of an area of the modular thermal panel.

In additional or alternative configurations, the enclosed channels occupy 45% or more of an area of the modular thermal panel.

In additional or alternative configurations, the enclosed channels correspond to ridges in an outer contour of the modular thermal panel, and the ridges increase an outer surface area of the modular thermal panel by 3% relative to an outer surface area the modular thermal panel would have if the outer contour were flat without ridges.

In a additional or alternative configurations, an albedo of a face of the modular thermal panel is 30% or greater for a blackbody spectrum of 25 degrees centigrade.

In a additional or alternative configurations, an emissivity of a face of the modular thermal panel is 30% or greater at 25 degrees centigrade.

In a additional or alternative configurations, an albedo of a face of the modular thermal panel is 20% or greater for a blackbody spectrum of 25 degrees centigrade.

In a additional or alternative configurations, an emissivity of a face of the modular thermal panel is 20% or greater at 25 degrees centigrade.

In a additional or alternative configurations, a ratio of a surface area of the modular thermal panel to a footprint of the modular thermal panel is 145%.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A radiative heating and/or cooling system, comprising:
modular thermal emitters fixed within a building and being arranged to span a substantial part of an interior surface of the building, wherein:
each of the modular thermal emitters comprising a planar member having channels disposed therein conveying a thermal fluid from an inlet of one of the modular thermal emitters to an outlet of the one of the modular thermal emitters, and
the plurality of modular thermal emitters comprises a fluid conduit configured to convey the thermal fluid from the outlet of the one of the modular thermal emitters to an inlet of another of the modular thermal emitters; and
a controller configured to control a flow of the thermal fluid through the modular thermal emitters.

2. The system accordingly to claim 1, further comprising a humidity regulator that measures a humidity of the building and modifies the humidity to maintain a dew point temperature below a temperature of the plurality of modular thermal emitters.

3. The system accordingly to claim 1, wherein the interior surface is a wall and/or a ceiling of an enclosed space of the building, and the building is a residential building, a commercial building, or an industrial building.

4. The system accordingly to claim 1, wherein the one of the modular thermal emitters in fluid communication with the another of the modular thermal emitters via the fluid conduit without any mechanical connectors along a pathway of the thermal fluid from the one of the modular thermal emitters to the another of the modular thermal emitters.

5. The system accordingly to claim 1, wherein the modular thermal emitters are reconfigurable without disassembling the interior surface of the building.

6. The system accordingly to claim 1, wherein the modular thermal emitters are fixed to the interior surface of the building using a channel support structure that is fixed to the interior surface, and channels in the channel support structure hold the modular thermal emitters along a periphery of the modular thermal emitters.

7. The system accordingly to claim 6, wherein the channel support structure comprises anti-uplift structures that prevent movement of the modular thermal emitters in response to a change in room pressure.

8. The system accordingly to claim 1, wherein the modular thermal emitters are fixed to the interior surface of the building using one of:
one or more fasteners secured to the interior surface of the building through one or more preformed attachment points within the respective modular thermal emitters,
attachments to a support lattice for a suspended ceiling,
one or more fasteners securing the modular thermal emitters to framing members, rafters, ceiling beams, or ceiling trusses,
a channel supporting a perimeter of the modular thermal emitters, fasteners fixing the channel either to one or more sheets of dry wall, one or more CMU, or structural wall or ceiling, or
suspending the modular thermal emitters from a structural ceiling using suspension wire or using a suspension fastener.

9. The system accordingly to claim 1, wherein, when the thermal fluid fills the channels of a respective modular thermal panel of the of modular thermal emitters, a ratio of a thermal mass of the thermal fluid to a thermal mass of the respective modular thermal panel is greater than 0.5.

10. The system accordingly to claim 1, wherein the modular thermal emitters are fixed to the interior surface in a manner that reduces a plenum space relative to a forced air heating and/or cooling system.

11. The system accordingly to claim 1, wherein a temperature of the thermal fluid changes in a direction towards a room temperature as the thermal fluid flows through the respective modular thermal emitters, and an order of the thermal fluid flow through the respective modular thermal emitters is set to more uniformly heat and/or cool the building relative to an order of the thermal fluid flow in which the thermal fluid flow is conveyed from a current modular thermal panel to a next closest modular thermal panel.

12. The system accordingly to claim 1, wherein the modular thermal emitters are preassembled into groups of two or more modular thermal emitters thereby improving ease of installation.

13. The system accordingly to claim 12, wherein the groups of two or more modular thermal emitters are configured to be installed by sliding the groups of two or more modular thermal emitters into respective channels attached to the interior surface of the building.

14. The system accordingly to claim 1, further comprising a thermal insulator in thermal communication with a first face of the planar member, the first face facing towards a plenum space.

15. The system accordingly to claim 14, further comprising a thermal conductor in thermal communication with a second face of the planar member, the second face facing away from the plenum space and towards am interior of the building, the thermal conductor being one of a ceiling tile, an acoustic tile, a decorative tile, a wall panel, a plaster, or one or more sheets of drywall.

16. The system accordingly to claim 1, wherein the channels are non-circular and are molded between two sheets that form the planar member.

17. The system accordingly to claim 1, wherein an input channel conveys the thermal fluid from an inlet, the input channel fans out and bifurcates into branches spanning a substantial part of the planar member, and the branches combine to form an output channel conveying the fluid to an outlet.

18. The system accordingly to claim 1, wherein the channels are shaped to turbulate a flow of the thermal fluid and to provide a more even heat distribution throughout the channels.

19. The system accordingly to claim 18, wherein the channels are shaped to include off-center obstructions that turbulate the flow of the thermal fluid.

20. The system accordingly to claim 1, wherein the building is zoned to have a greater density of the modular thermal emitters in zones requiring more heat transfer.

21. The system accordingly to claim 1, wherein
the modular thermal emitters are attached to a suspended ceiling using an attachment structure configured to attach to a horizontal portion of a support lattice of the suspended ceiling, wherein
a lower portion of the support lattice has a cross-section shaped as an inverted T-shape and the horizontal portion of the support lattice corresponds to a bottom of the inverted T-shape, and
the attachment structure includes a hook that extends around one end of the horizontal portion of the support lattice and includes a foldable tab that folds over another end of the horizontal portion of the support lattice.

22. A modular thermal panel, comprising:
a planar member comprising a thermal conductor having enclosed channels disposed therein, the enclosed channels being configured to provide flow of a fluid from an input channel to an output channel, and the enclosed channels fanning out from the input channel into a plurality of branches and then recombining to form the output channel;
an inlet port in fluid communication with the input channel and configured to feed the fluid into the heat exchanger; and
an outlet port in fluid communication with the input channel and configured to receive the fluid exiting the heat exchanger.

23. A support rail for supporting modular thermal emitters in a suspended ceiling, comprising:
a first support member comprising an elongated member with a cross-section having an inverted T-shape comprising an upright portion and a horizontal portion, the horizontal portion being configured to support a modular thermal panel, the elongated member being configured to attach to a support lattice of a suspended ceiling and/or attach to a structural ceiling via a suspension wire; and
a second support member configured perpendicular to the first support member, the second support member comprising an elongated member with a cross-section having an inverted T-shape comprising an upright portion and a horizontal portion, the horizontal portion being configured as a support the modular thermal panel, and second support member being configured to connect to the first support member, wherein:
the first support member and the second support member, when connected together, form a part of a support lattice that supports a plurality modular thermal emitters in a suspended ceiling.
